(19) United States
(12) Patent Application Publication
(10) Pub. No.: US 2017/0248115 A1
(43) Pub. Date: Aug. 31, 2017

(54) Optimized Multiple Airfoil Wind Turbine Blade Assembly

(71) Applicant: Howard Harrison, Mississauga (CA)

(72) Inventor: Howard Harrison, Mississauga (CA)

(21) Appl. No.: 15/509,916

(22) PCT Filed: Sep. 9, 2015
(86) PCT No.: PCT/CA2015/000485

§ 371 Date: Mar. 9, 2017

Related U.S. Application Data
(60) Provisional application No. 62/048,103, filed on Sep. 9, 2014.

(51) Int. Cl. F03D 1/06; F03D 7/02

(52) U.S. Cl. CPC F03D 1/0633; F03D 1/0675; F03D 7/022; F05B 2230/50; F05B 2240/30

(57) ABSTRACT

A method for optimizing multiple airfoil wind turbine blades, having, specifically, at least a primary airfoil and a secondary airfoil with an aerodynamic gap therebetween. an optimized multiple airfoil wind turbine blade assembly, and a modular method for manufacturing and assembling the same.

### CROSS REFERENCE TO RELATED APPLICATION

This application claims the benefit of and priority to U.S. Provisional Patent Application No. 62/048,103 filed Sep. 9, 2014.

The content of the above patent application is hereby expressly incorporated by reference into the detailed description hereof.

### FIELD OF THE INVENTION

The present invention generally relates to the effective capture of power from wind, and the conversion of that power into electricity or other usable forms of energy. More particularly, the invention relates to a novel multiple airfoil wind turbine blade design that has been optimized to increase the effectiveness and efficiency of capturing power from wind.

### BACKGROUND OF THE INVENTION

Wind turbines have become an acceptable source of “green” electrical energy; however current designs have a few drawbacks that are preventing more widespread use. These include high cost, large size, which some consider unsightly, and noise. At the root of these problems is a less than ideal conversion of the wind's kinetic energy to the power produced by the turbine blades. A more efficient conversion is desirable since wind turbines could then produce more electrical power while blade length remained the same, or conversely, shorter blades would produce the same amount of electrical power from the wind, resulting in less expensive turbines, lower blade tip speeds and reduced noise. Further, a turbine with a variable aerodynamic response to the wind could be controlled to generate power more efficiently across a wider range of wind and load conditions.

### SUMMARY OF THE INVENTION

An optimized multiple airfoil wind turbine blade assembly with improved efficiency and control characteristics as compared to prior art wind turbine blade designs is disclosed. This is achieved by optimizing the multiple airfoil wind turbine blade assembly for aerodynamic performance, resistance to stall, overall mass, structural integrity and manufacturability. Replacing conventional wind turbine blades with multiple airfoil wind turbine blade assemblies, so optimized, would boost the performance, of existing wind turbines without requiring further changes to other components such as the hub and bearings. This in turn would lead to increased energy production and reduced cost of electricity from wind.

The optimized multiple airfoil assembly disclosed herein may be configured with two independent airfoils, held in fixed relative position such that they cooperate aerodynamically to produce more power than a single blade having similar overall dimensions, when driven by the same wind. The two independent airfoils may be joined at the root and the tip, to form a “box wing” type structure that has greater structural rigidity than a conventional or single wind turbine blade.

It has been found that the enhanced performance of the optimized multiple airfoil assembly is due to three fundamental aerodynamic principles. In a preferred embodiment, a dual airfoil or “biplane” blade assembly provides greater overall lift than a traditional or single airfoil blade assembly, at a higher Angle of Attack (AoA), and an improved lift to drag ratio. Second, the lower rotational speeds and delayed stall associated with the “biplane” configuration greatly enhance the dynamic or rotational stall effect that is associated with rotating blades. And third, the combined tips not only provide structural integrity but they also increase the span efficiency of the combined airfoils by reducing the induced drag of the multiple airfoil assembly. The inventor has, through research, experimentation and software modelling, been able to combine these three aerodynamic principles in a novel manner to provide the substantial performance advantages associated with the multiple airfoil assembly taught herein. Further, the invention teaches various means to control and optimize the enhanced dynamic stall phenomena, thereby further increasing the performance advantages associated with the multiple airfoil assembly taught herein.

### BRIEF DESCRIPTION OF THE DRAWINGS

Embodiments will now be described more fully with reference to the accompanying drawings in which:

FIG. 1 provides a comparison of XFOIL and NACA experimental results for Clark Y and NACA 4415 airfoils,

FIG. 2 provides a comparison of Clark Y monoplane corrected and XFOIL results,

FIG. 3 provides a comparison of initial Clark Y BEM and NACA 4415 experimental results,

FIG. 4a provides a comparison of total lift for biplane and monoplane configurations using NACA 317 corrected data,

FIG. 4b provides a comparison of the lift/drag ratios for biplane and monoplane configurations using NACA 317 corrected data,

FIG. 5 presents Clark Y biplane Cₗ and C_{d} curves with corrigan stall delay,

FIG. 6 provides a comparison of ( [symbol] −α_{g}) for biplane and monoplane configurations,

FIG. 7 provides a comparison of Clark Y BEM with stall delay and NACA 4415 results,

FIG. 8 summarizes the span efficiency for various nonplanar airfoil configurations,

FIG. 9 presents Prandtl vs. reduced tip losses for multiple airfoil wind turbines,

FIG. 10 presents Clark Y BEM with stall delay and reduced tip loss vs. NACA 4415,

FIG. 11 is a flowchart summarizing the multiple airfoil optimization method,

FIG. 12 presents a summary of optimized multiple airfoil configurations,

FIG. 13 presents a front view of a conventional wind turbine configured with a single rotor having three blades at 120° intervals,

FIG. 14 presents a front view of a conventional wind turbine configured with three multiple airfoil wind turbine assemblies,

FIG. 15 presents a front view of a multiple airfoil assembly with a primary airfoil and a secondary airfoil,

FIG. 16 presents a side view of the multiple airfoil assembly with a primary airfoil and a secondary airfoil,

FIG. 17 presents a side view of a conventional wind turbine configured with multiple airfoil assemblies,

FIG. 18 presents a side cutaway view of a multiple airfoil assembly in a horizontal orientation, showing the internal beam structure,

FIG. 19 presents a cross section view of a secondary airfoil with an internal spar structure,

FIG. 20 presents a side view of the internal spar structure,

FIG. 21 presents a cutaway view of a tooling configuration for a multiple airfoil assembly, and

FIG. 22 presents a front view of a multiple airfoil assembly with an adjustable radial flow deflector.

### DETAILED DESCRIPTION OF THE EMBODIMENTS

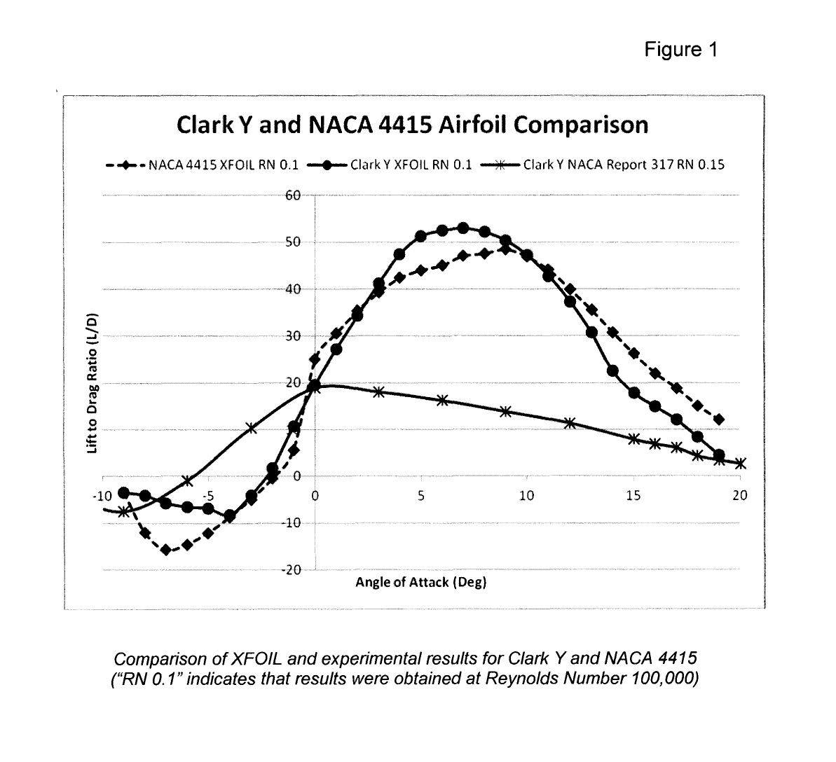

Turning now to FIGS. 1-12, a method for optimizing multiple airfoil wind turbine blade assemblies shall be described in detail.

While it is commonly known that a multiple airfoil or “biplane” configuration may provide more lift than a single airfoil or “monoplane” configuration, it has been found that the more favourable lift to drag (L/D) ratio, with respect to Angle of Attack (AoA), and larger difference in AoA between “no lift” and “max lift” associated with the former have a greater impact on multiple airfoil wind turbine performance.

The difference in these characteristics may be quantified by selecting a representative airfoil such as the Clark Y, and correcting the available biplane data for 3D effects so that the lift and drag characteristics may be compared with 2D monoplane data available from standard sources such as XFOIL. The available biplane data, which is primarily from the 1920s and 1930s, or the “biplane era”, includes these 3D effects because testing was done using wing sections with various features such as rounded tips.

The biplane 3D correction process, once developed, may be validated by using the same methodology to correct the available single airfoil or monoplane 3D data, and comparing it with the 2D monoplane data from XFOIL, for the same airfoil. If the 2D corrected and XFOIL results are reasonably close then one may conclude that the correction methodology is also reasonably accurate for 3D biplane effects.

It is important to note that the 3D correction process is essential for wind turbine development purposes. This is because the standard wind turbine modeling and design tools, based on Blade Element Momentum (BEM) theory, require 2D data when inputting the aerodynamic characteristics for each element of the blade, whether single or multiple airfoil. It follows that BEM model results achieved in this manner may be compared with experimental multiple airfoil wind turbine results to further validate the 3D correction process.

Clark Y biplane and monoplane 3D data was obtained from NAGA Report 317, written by Montgomery Knight and Carl J. Wenzenger of Langley Memorial Aeronautical Laboratories in 1930. The aerodynamic tests they performed were indeed three dimensional because the wing sections included circular tips at a Reynolds number of approximately 153,000. Monoplane data was obtained from Table 6. Biplane data was obtained from Tables 15 and 17, with the biplane configurations having a gap ratio of 1, decalage angle of 0 and a stagger ratio of 0 and 0.5, respectively. Gap and stagger ratios, in this case, refer to the ratio of the gap or stagger to the chord length of the wing section.

While the Clark Y data was readily available, it was unfortunately not the same airfoil that was used to obtain the multiple airfoil wind turbine experimental results, which in this case was a NACA 4415. However, as previously noted, the aerodynamic parameter of greatest interest for wind turbine development is the lift to drag (L/D) ratio, with respect to Angle of Attack (AoA). Hence it follows that the multiple airfoil BEM and experimental results could be reasonably compared if the magnitude, and more importantly the shape, of the L/D curves are similar for the Clark Y and NACA 4415 airfoils.

The L/D curve may be plotted by determining the Cₗ/C_{d} ratio (Coefficient of Lift/Coefficient of Drag) at each AoA of interest. Initially it was found that the Clark Y L/D curve obtained from data in the NACA 317 report, Table 15, compared poorly with the NACA 4415 L/D curve, as may be seen in FIG. 1. The L/D ratio of Clark Y is much less than the L/D ratio of NACA 4415 at every AoA, and the max L/D ratio of the two airfoils occurs at different AoAs. However, it was commonly known at the outset that both the Clark Y and NACA 4415 airfoils have very similar C₁ curves, as documented by sources such as XFOIL. Thus, the observed differences in the L/D curves must be due to differences in the C_{d} curve, and more specifically that the lower L/D curve associated with Clark Y must be caused by higher C_{d} values. It is theorized that these higher C_{d} values are due to induced drag, which is known to be present in 3D test results. This theory is further supported by the XFOIL 2D simulation results for Clark Y, where the L/D curve is very similar to the NACA 4415 L/D curve, also shown in FIG. 1.

This theory may be supported by correcting the Clark Y 3D data from NACA Report 317 for induced drag, in an attempt to improve its agreement with the 2D Clark Y XFOIL results and its correlation to the NACA 4415 L/D curve. The new 2D drag coefficient, C_{d,2d} is found by subtracting the calculated induced drag coefficient C_{d,i} from the experimentally obtained total drag coefficient C_{d,experiment}:

C_{d,2d}=C_{d,experiment}−C_{d,i}

For a monoplane, the induced drag coefficient, C_{d,i} can be found by using the following formula;

$${C}_{d . i} = \frac{{C}_{L}^{2}}{π * e * {AR}_{m}}$$

Where C_{L} is the lift coefficient, e is the span efficiency (assumed to be 1 for the monoplane) and ARₘ is the monoplane aspect ratio.

For a biplane, the induced drag coefficient calculation is more complex, and it is based on Prandtl's work (NACA TN-182, Induced Drag of Multiplanes by L. Prandtl). The application of Prandtl's formula used in this analysis is as described in the VKI lecture series title “The Prandtl Wing” by Prof. Aldo Frediani. A complete explanation is contained within the Frediani work and thus only a brief summary is given below.

The underlying drag equation used for a monoplane is still applicable to the biplane configuration; however, special attention must be paid to the definition of the lift coefficient C_{L}, the span efficiency, e and the definition of the biplane aspect ratio, AR_{b}.

$${C}_{d , i} = \frac{{C}_{L}^{2}}{π * e * {AR}_{b}}$$

In this case the lift coefficient C_{L} is defined as;

$${C}_{L} = \frac{{L}_{total}}{\frac{1}{2} ρ {V}^{2} {S}_{total}}$$

where the total lift of the biplane, Lₜₒₜₐₗ=L₁+L₂ is a summation of the lift of the upper and lower wings, ρ is the air density, V is the free stream velocity and Sₜₒₜₐₗ is the combined planform area of the two wings.

The span efficiency of a biplane is given by the equation below and it is a function of σ, the interference factor.

$$e = \frac{1}{x} = \frac{2}{1 + σ}$$

For a biplane with wings of equal span, and where the lift is distributed equally between the upper and lower wings, i.e. L₁=L₂, the interference factor, σ is given by;

$$σ = \frac{1}{1 + 5.3 \frac{g}{b}}$$

where g is the gap, defined as the vertical distance between the leading edges of the upper and lower wings, and b=(b₁+b₂)/2, i.e. the average wing span. It is interesting to note that the interference factor is a function of the gap to span ratio only. The contribution of stagger and decalage is not immediately clear in this equation. However, it has been theorized that stagger and decalage may be used to balance the wing loading such that the condition L₁=L₂ holds true.

Finally, the biplane aspect ratio, AR_{b}, is defined as the upper wing span, b₁, squared over the total planform area, Sₜₒₜₐₗ.

$${AR}_{b} = \frac{{b}_{1}^{2}}{{S}_{total}}$$

For a biplane with the same span and planform area per wing as a monoplane, the biplane aspect ratio is half that of the monoplane due to the doubling of the total planform area.

A numerical example may be used to illustrate the application of the above equations and principles. For a rectangular wing with a span b=30 inches and a constant chord cₘ=5 inches, calculate the monoplane aspect ratio, ARₘ. Find the biplane chord, c_{b} such that biplane aspect ratio AR_{b}=ARₘ, given the upper and lower wing span are equal, and calculate the corresponding span efficiency of the biplane, e. Then calculate the induced drag C_{d,i} given that C_{L} and C_{d,experiment} are 1.012 and 0.073 respectively, at an AoA of 10 degrees. For the biplane, a gap of 1 chord is assumed, with equal span and lift distribution.

### Aspect Ratio Calculation;

$${AR}_{m} = \frac{{b}^{2}}{S} = \frac{{b}^{2}}{b * {c}_{m}} = \frac{b}{c} = \frac{30}{5} = 6$$

$${AR}_{b} = 6 = \frac{{b}_{1}^{2}}{{S}_{total}} = \frac{{b}_{1}^{2}}{{b}_{i} * {c}_{b} + {b}_{2} * {c}_{b}} = \frac{{b}_{1}^{2}}{{b}_{1} * {c}_{b} * 2} = \frac{{b}_{1}}{{c}_{b} * 2} ⇒ {c}_{b} = \frac{{b}_{1}}{{AR}_{b} * 2} = \frac{30}{6 * 2} = 2.5$$

### Biplane Span Efficiency Calculation;

$$g = c = 2.5$$

$$σ = \frac{1}{1 + 5.3 \frac{g}{b}} = \frac{1}{1 + 5.3 \frac{2.5}{30}} = 0.694$$

$$e = \frac{2}{1 + σ} = \frac{2}{1 + 0.694} = 1.181$$

### Induced Drag Calculation;

### Monoplane:

$${C}_{d , i} = \frac{{C}_{L}^{2}}{π * s * {AR}_{m}} = \frac{{( 1.012 )}^{2}}{π * 1 * 6} = 0.0543$$

### Biplane:

$${C}_{d , i} = \frac{{C}_{L}^{2}}{π * s * {AR}_{m}} = \frac{{( 1.012 )}^{2}}{π * 1.181 * 6} = 0.046$$

A first observation from these calculations was that the induced drag of a biplane is substantially less than that of the monoplane, albeit under these particular conditions, a characteristic which shall subsequently be used when reviewing a further aerodynamic principle for multiple airfoil blade assemblies for wind turbines; reduced tip loss.

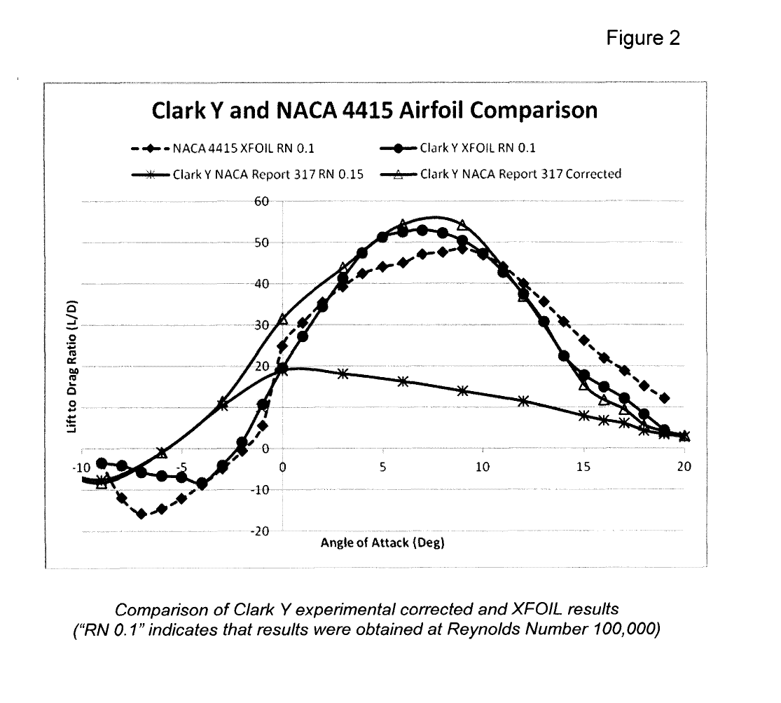

The induced drag correction (as described and illustrated above) was then applied to the 3D Clark Y monoplane data from the NACA 317 report, and it was found that the lift to drag ratio curve of the corrected experimental data was in good agreement with the Clark Y XFOIL 2D simulation results, as illustrated in FIG. 2. In particular, there was a noticeable upward shift in the magnitudes of the lift to drag ratio and an increase in the AoA where peak lift to drag ratio occurs. This was a direct result of the new corrected drag curve, i.e. the calculated values of C_{cup} plotted against AoA, which is now very close to the drag curve of the XFOIL results.

Therefore it can be concluded that the above induced drag correction would also be a reasonably accurate methodology for correcting experimental biplane 3D data, so that it may be used as input for wind turbine modelling and design tools. Further assurance was provided by the fact that similar upward shifts in the lift to drag ratios and max AoA were observed in the Clark Y biplane data, after applying this induced drag correction, although direct comparison with XFOIL results is not possible at this time.

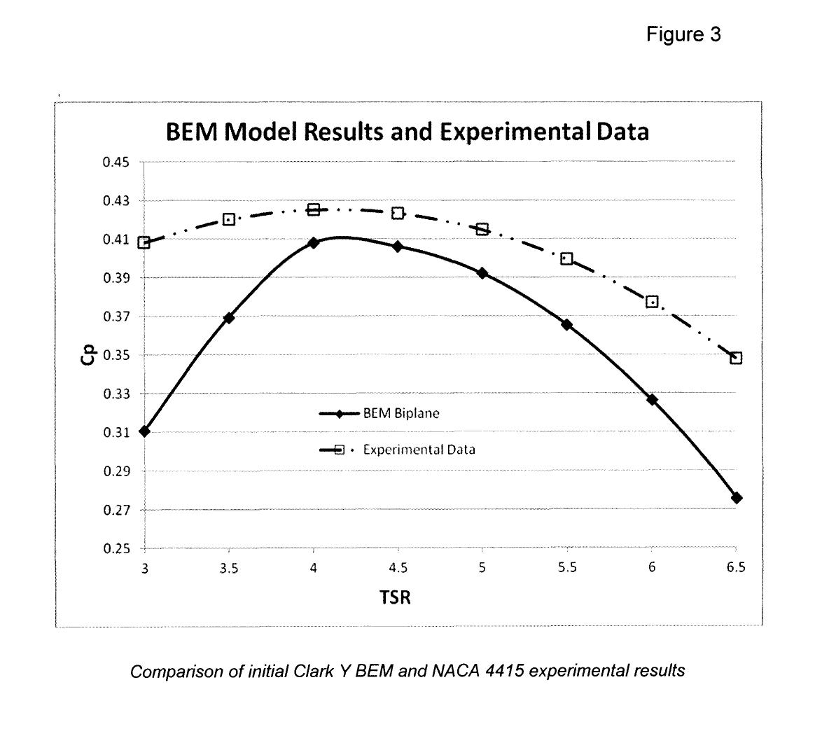

Based on this preliminary conclusion, the next step in the inventive process was to apply the induced drag correction to experimental results from the Clark Y biplane test configuration that most closely matched NACA 4415 multiple airfoil experimental wind turbine configuration, so that the Clark Y BEM model results could be compared with the NACA 4415 wind turbine experimental results for validation purposes. After completing this analysis, however, it was found that the results did not compare well, as illustrated in FIG. 3.

The performance predicted by the Clark Y BEM model fell short of experimental results for all TSR values, and furthermore the shape of the BEM predicted curve was significantly different than the shape of the experimental curve. Nonetheless it was decided that the preliminary conclusion regarding the above noted induced drag correction was reasonable, and that the remaining discrepancy in the results was more likely due to other factors which were unknown at the time.

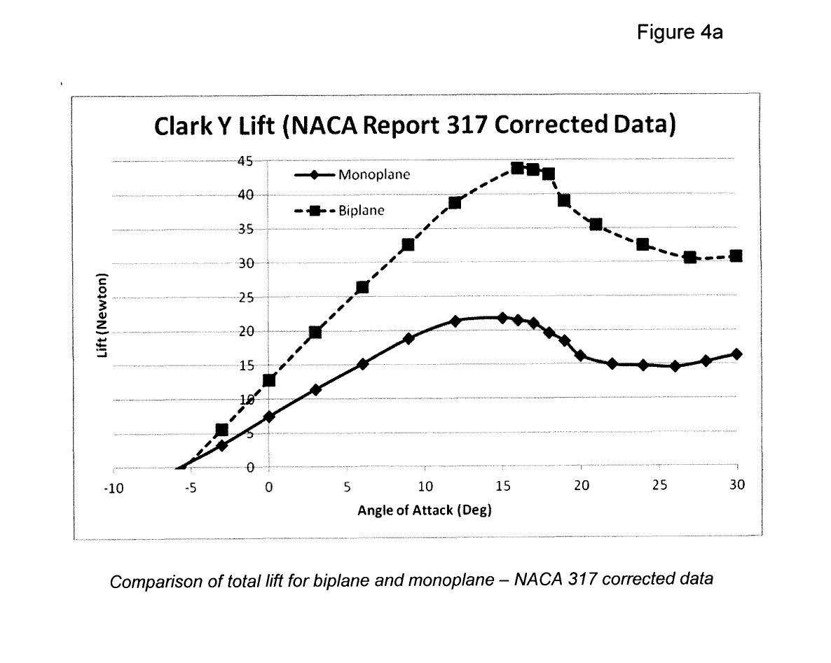

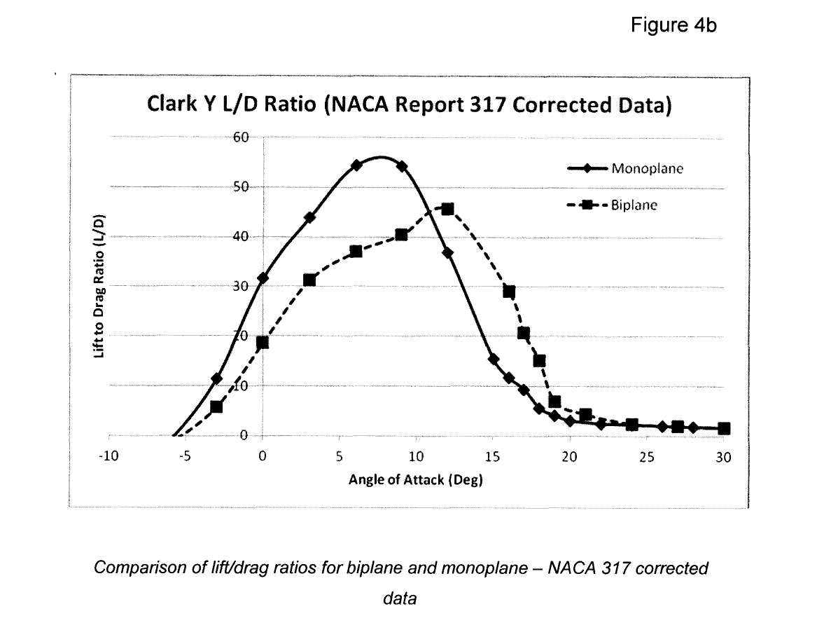

However before moving on, the induced drag correction results were documented in order to illustrate the first aerodynamic principle, i.e. that multiple airfoil configurations provide greater lift and, more importantly, better lift/drag characteristics than single airfoil configurations. It may be observed from FIG. 4a that the total lift associated with the biplane configuration is indeed substantially greater than the monoplane lift, primarily due to a doubling of the planform area, and that maximum lift occurs at a slightly higher AoA.

It should also be noted from FIG. 4b that the biplane Cₗ/C_{d} ratio is actually greater at higher AoAs, and more interestingly that it exceeds the monoplane Cₗ/C_{d} ratio in the range of AoAs that correlates well with maximum biplane lift. To illustrate the point, a biplane configuration operating at an AoA of 15 degrees provides approximately twice the lift at three times the Cₗ/C_{d} ratio, relative to a monoplane configuration. These observations are consistent with the experimental results, which confirmed that a multiple airfoil wind turbine produces approximately 16% more maximum power than a traditional wind turbine, at a lower tip speed ratio (TSR). The lower rotational speed requires more torque to produce the same power, which is consistent with the greater available lift, and it also results in higher AoA values, which is consistent with the observed region of higher Cₗ/C_{d} ratios in the corrected biplane data.

An understanding of these aerodynamic characteristics is critical for the optimization of multiple airfoil wind turbine performance, and it may be used to evaluate other potential airfoils and/or combinations of potential airfoils for this purpose. It was found, for example, that reducing the chord length of one airfoil relative to the other changes these characteristics in a favourable manner, for use with multiple airfoil wind turbines. Further, it should be noted that reducing the chord length of the upwind airfoil, relative to the downwind airfoil, also reduces the overall mass of a multiple airfoil blade assembly, thereby providing additional mechanical and structural benefits.

The second major aerodynamic principle found to be associated with multiple airfoil blade assemblies for wind turbines was that the lower rotational speeds and delayed aerodynamic stall associated with the biplane configuration combine to greatly enhance the dynamic or rotational stall effect that is associated with rotating blades. This is not obvious to one familiar with the aerodynamic characteristics of the biplane configuration in a fixed or non-rotating configuration, such as an airplane.

The optimum Tip Speed Ratio (TSR), i.e. the TSR where the coefficient of performance (Cp) of the wind turbine is maximized, is characteristically lower for a multiple airfoil wind turbine, relative to its traditional three blade counterpart. As a result, a multiple airfoil wind turbine operates at higher angles of attack (AoAs). Given the higher AoAs, the inboard region of the multiple airfoil blade assembly should be operating in the post-stall region, according to corrected 2D wind tunnel data, and not generating any power. However, there was strong evidence in the experimental data that a multiple airfoil wind turbine actually continues to generate substantial power at less than optimum TSR. This is illustrated in FIG. 3, where it may be seen that the BEM simulation results fall off sharply below the optimum TSR, because they are based on a traditional understanding of dynamic stall, whereas the experimental results remain quite high. Note that these observations are based on the “shape” of the two curves and not the actual Cp values.

Stall delay due to rotational effects is currently the subject of much research. Generally speaking, it is understood that the rotation of the blade causes a radial component of flow due to centrifugal forces, thus adding momentum to the local boundary layer at the inboard region of the blade and delaying flow separation.

It is hypothesized that enhanced multiple airfoil rotational stall delay may explain the aforementioned divergence between the BEM simulation and experimental results at lower TSRs, as outlined above. Again, it should be noted that stall delay due to rotational effects is more critical for multiple airfoil wind turbines because they operate at lower TSRs, resulting in higher AoAs along the blade, i.e. in a region where the blade assemblies would normally stall based on the 2D data. If this hypothesis is proven true then it may provide further means to control a multiple airfoil wind turbine. For example the turbine could be allowed to spin faster, initially, to set up the radial component of flow, then slowed down to take advantage of stall delay. This algorithm would also reduce the operating tip speed, thereby reducing noise. Alternatively, certain features could be built into the blade assembly to deflect a greater or lesser portion of the flow in a radial direction, thus controlling the enhanced delayed stall effects.

There are a number of proposed stall delay models in the literature, including Snel et al, Du and Selig, Chiviaropoulos and Hansen, Corrigan and Shillings, and Bak et al. The complexity of these stall delay models varies, as does the accuracy of their results. As such, there is not a well established stall delay model at the moment, even for traditional or single airfoil designs.

As a first attempt, Corrigan and Shillings' stall delay model was employed because it appeared to be capable of accounting for the observed differences in the biplane and monoplane 2D aerodynamic data, though this was not likely the original intent. The application of the model is described by Tangier, J. L and Selig, M. S. (“An evaluation of an empirical model for stall delay due to rotation for HAWT's”, 12 pp.; NREL Report No. CP-440-23258), and may be summarized as follows;

$$Δα = ( {α}_{{C}_{{i}_{max}}} - {α}_{0} ) [ {( \frac{K \frac{c}{r}}{0.136} )}^{n} - 1 ]$$

where,

$$K = {( \frac{C}{0.1517 r} )}^{\frac{1}{1.084}}$$

In this model, a stall delay angle, Δα, is calculated based on the local chord divided by radial distance c/r, the 2D stall angle [symbol] , the 2D zero lift angle αₒ, and the exponent n. The first four parameters can be found from the geometry and aerodynamic properties of the turbine blade. It should be noted that in the case of multiple airfoil wind turbine blade assembly the difference between [symbol] and αₒ is characteristically higher than for a traditional blade. This is critically important because it provides a higher stall delay angle, thus contributing to the enhanced rotational stall delay observed in the multiple airfoil wind turbine experimental results.

The exponent n is determined empirically and it is proportional to the strength of the centrifugal term. For n=0, the stall delay becomes zero, which is characteristic of the 2D data. Corrigan indicates that varying n from 0.8 to 1.6 provides good correlation with most test data, and further that n=1 provides reasonable results for most cases. Thus, n=1 was used for the initial analysis. However, other sources, e.g. Xu and Sankar from Georgia Tech, suggest that n=1.8-1.9 provided the best match to experimental data in their particular case.

The stall delay angle must be calculated for every radial element, as defined in the BEM model. These calculations are best performed with the aid of a spreadsheet, as shown in Table 1 below. In this case the example is based on the aforementioned Clark Y biplane data from the NACA 317 report, corrected for 3D effects.

TABLE 1
Corrigan Stall Delay Calculations for Clark Y Biplane (NACA 317 Report)
N 1.6
R 2.5
cl slope 0.064

| | | | | | alpha | alpha | delta | | |
|---|---|---|---|---|---|---|---|---|---|
| r/R | r | c | c/r | K | max | zero | alpha | ((K*(c/r))/0.136)\hat{ }n | delay alpha |
| 22.5% | 0.563 | 0.287 | 0.510 | 0.327 | 16 | −5.3 | 21.3 | 1.384 | 8.180 |
| 27.5% | 0.688 | 0.280 | 0.407 | 0.402 | 16 | −5.3 | 21.3 | 1.346 | 7.370 |
| 32.5% | 0.813 | 0.273 | 0.336 | 0.480 | 16 | −5.3 | 21.3 | 1.314 | 6.696 |
| 37.5% | 0.938 | 0.266 | 0.284 | 0.561 | 16 | −5.3 | 21.3 | 1.287 | 6.116 |
| 42.5% | 1.063 | 0.259 | 0.244 | 0.645 | 16 | −5.3 | 21.3 | 1.263 | 5.608 |
| 47.5% | 1.188 | 0.252 | 0.212 | 0.733 | 16 | −5.3 | 21.3 | 1.242 | 5.150 |
| 52.5% | 1.313 | 0.245 | 0.187 | 0.825 | 16 | −5.3 | 21.3 | 1.222 | 4.735 |
| 57.5% | 1.438 | 0.239 | 0.166 | 0.920 | 16 | −5.3 | 21.3 | 1.204 | 4.353 |
| 62.5% | 1.563 | 0.232 | 0.148 | 1.021 | 16 | −5.3 | 21.3 | 1.188 | 3.997 |
| 67.5% | 1.688 | 0.225 | 0.133 | 1.127 | 16 | −5.3 | 21.3 | 1.172 | 3.664 |
| 72.5% | 1.813 | 0.218 | 0.120 | 1.239 | 16 | −5.3 | 21.3 | 1.157 | 3.349 |
| 77.5% | 1.988 | 0.211 | 0.109 | 1.357 | 16 | −5.3 | 21.3 | 1.143 | 3.049 |
| 82.5% | 2.063 | 0.204 | 0.099 | 1.482 | 16 | −5.3 | 21.3 | 1.130 | 2.763 |
| 87.5% | 2.188 | 0.197 | 0.090 | 1.615 | 16 | −5.3 | 21.3 | 1.117 | 2.486 |
| 92.5% | 2.313 | 0.191 | 0.082 | 1.756 | 16 | −5.3 | 21.3 | 1.104 | 2.219 |
| 97.5% | 2.438 | 0.184 | 0.075 | 1.907 | 16 | −5.3 | 21.3 | 1.092 | 1.961 |

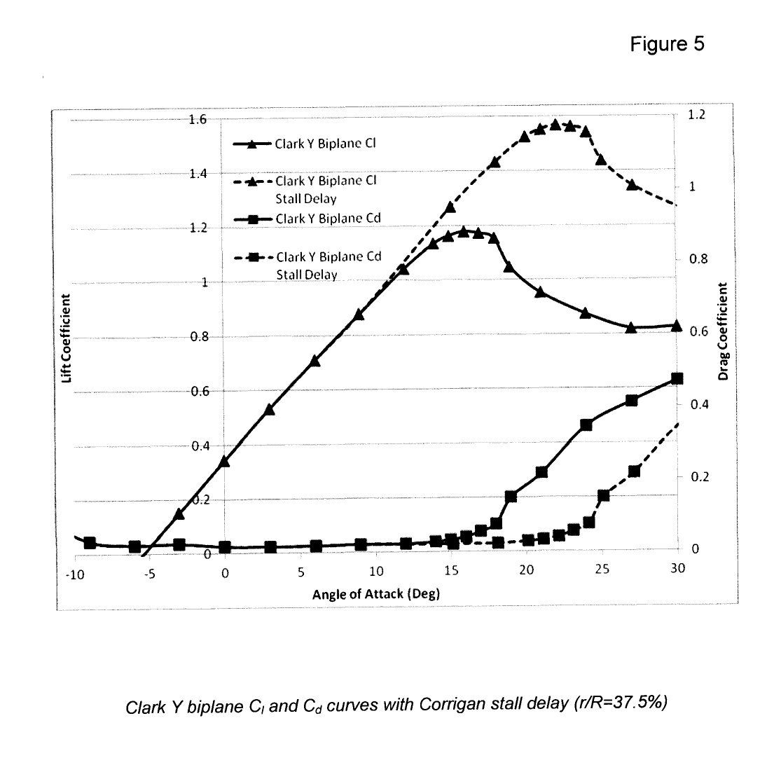

Once the stall delay angles are calculated they can be applied to the linear region of the 2D aerodynamic data for each blade element, as illustrated in FIG. 5 for the blade element that is located at 37.5% of the total blade radius, i.e. r/R=37.5%. In this case the original and stall delay modified aerodynamic data are shown in solid and dashed lines, respectively. For the stall delay data it should be noted that the linear portion of the lift coefficient, Cₗ, curve has been extended with constant slope until it reaches a new AoA that was determined by adding the stall delay angle, Δα, to the original alpha max, [symbol] . In this case the stall delay angle, Δα, for r/R=37.5% was obtained from Table E, and it is 6.116 degrees. The drag coefficient, C_{d}, curve may be adjusted by simply extending the “constant” portion along the X axis by an amount that is equal to the same stall delay angle.

The end result is an “adjusted” set of Cₗ and C_{d} curves that may be used to determine the enhanced stall delay performance for each element on the rotating blade. For example, it is clear from the adjusted curved that the blade element will continue to produce power at AoA=20 degrees, when it would have normally stalled based on the unadjusted 2D aerodynamic curves in FIG. 5.

It can be observed from Table E that the range of stall delay angles, Δα, for the Clark Y biplane configuration is 1.961-8.180 degrees, whereas the range for an S809 airfoil in a monoplane configuration is only 0.653-3.135 degrees, as stated by Tangier and Selig in their NREL paper entitled “An Evaluation of an Empirical Model for Stall Delay due to Rotation for HAWTs”, as presented at Windpower '97 in Austin, Tex. While part of this discrepancy may be due to the differences in airfoils, it is now understood that it is predominantly due to the increased stall delay angle associated with a biplane configuration.

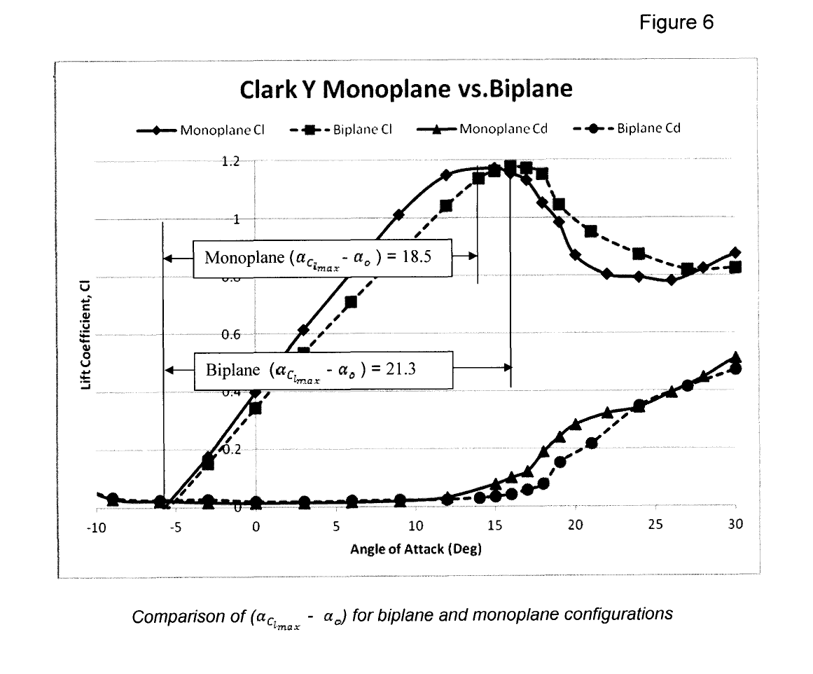

Further examination reveals that the biplane configuration is characterized by a higher [symbol] than the monoplane configuration, with approximately the same α_{o,} as shown by the dashed and solid lines, respectively, in FIG. 6. As a result the ( [symbol] −αₒ) term in the stall delay equation, repeated below for clarity, is larger for the biplane configuration, specifically 21.5 degrees vs. 18.5 degrees for the monoplane configuration. This has the desired effect of increasing the stall delay angle, Δα.

$$Δα = ( {α}_{{C}_{{i}_{max}}} - {α}_{0} ) [ {( \frac{K \frac{c}{r}}{0.136} )}^{n} - 1 ]$$

It should also be noted from FIG. 6 that biplane drag remains lower, for a longer period of time, and rises less abruptly than the monoplane drag. This will increase the L/D ratio in the pre-stall region, both before and after the rotational stall delay has been accounted for. However the effect will be greater after adjustment for rotational stall delay since Cₗ continues to rise whereas C_{d} remains relatively constant, resulting in an even higher Cₗ/C_{d} ratio in the rotational stall region.

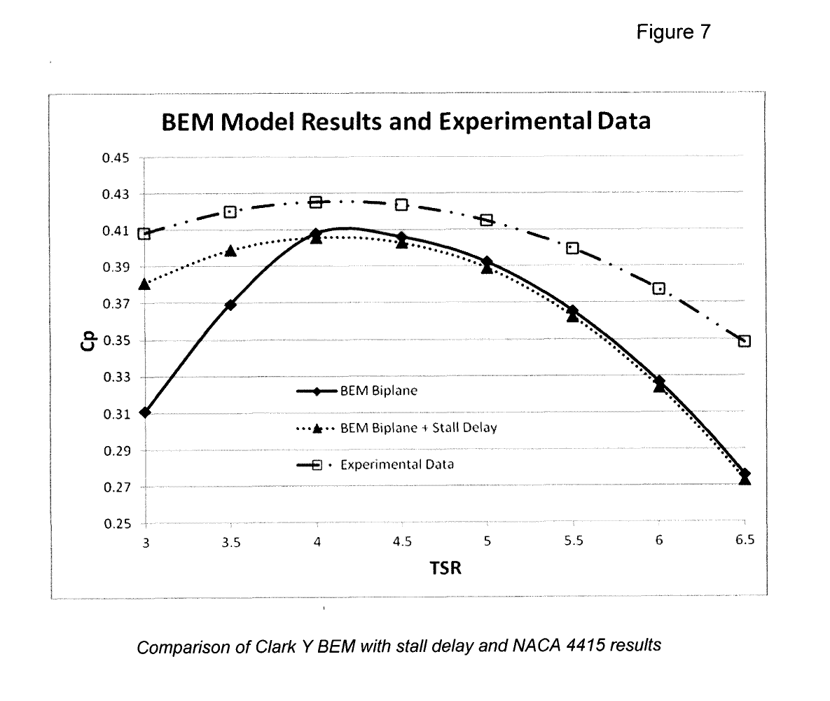

The actual impact of the enhanced rotational stall delay associated with multiple airfoil wind turbine blades was determined by completing the Corrigan stall delay analysis for a Clark Y biplane configuration, using the adjusted aerodynamic data for each element as input to the BEM model, and then comparing the new results with the experimental data, as shown in FIG. 7. It was immediately evident that the enhanced rotational stall delay decreased the discrepancy between the BEM model output and experimental results, and that the shape of the two curves became much more alike. It should be noted that the effects of the enhanced rotational stall delay were most pronounced at low TSRs, as expected. The best match was achieved with an exponent “n” value of 1.6, and it is possible that this could be improved by increasing the exponent further, as suggested by Xu and Sankar. However it is more likely that the persistent gap in actual performance across all TSRs is due to other factors.

Closer observation reveals that the gap between the stall delay and experimental curves actually increases as the TSR decreases below optimum TSR. This provides a clue that the gap may be due to reduced drag in the experimental results, which in turn is dependent upon the drag coefficient, C_{d}, and the square of the apparent wind speed. It follows that a lower C_{d} would lead to reduced drag, leading to increased performance in the BEM results and closing the gap between the two curves. Further, the effects would be enhanced at lower TSRs due to the squared dependence on apparent wind speed, accounting for the observed difference in the relative shapes of the curves.

This leads to a discussion of the third major aerodynamic principle found to be associated with multiple airfoil blade assemblies for wind turbines, which is that the combined tips not only provide structural integrity but they also increase the span efficiency of the configuration, by reducing the induced drag.

The aforementioned BEM model already incorporates a tip loss correction to properly account for the 3D losses due to spanwise flow along the blade, causing a reduction of lift in the tip region. However it is important to keep in mind that this “built in” tip loss correction is based on the standard Prandtl tip loss function, which predicts tip losses for a traditional three blade wind turbine.

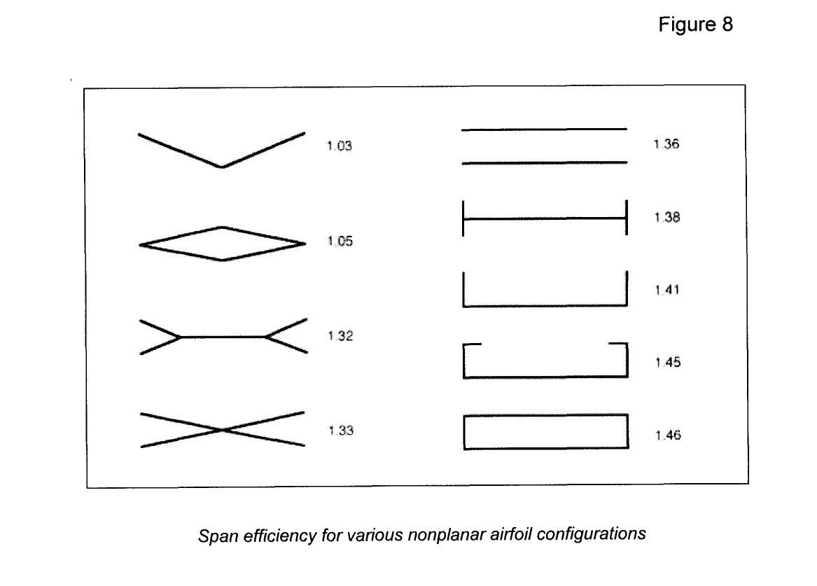

Elsewhere in the literature there are many references to the fact that biplane configurations have lower tip losses than monoplane configurations in fixed wing applications. As a result biplane configurations create less induced drag, making them more efficient than monoplane configurations. This is sometimes referred to as “span efficiency”, which is a measure of the increased aerodynamic efficiency due to reduced induced drag. FIG. 8 includes a summary of the span efficiency factors for a variety of fixed wing configurations, as presented by I. Kroo, Stanford University, at the VKI lecture series on Innovative Configurations and Advanced Concepts for Future Civil Aircraft, Jun. 6-10, 2005, in a paper entitled “Nonplanar Wing Concepts for Increased Aircraft Efficiency”

Again with reference to FIG. 8, it may be noted that the traditional biplane configuration (top right corner), which is closest to the multiple airfoil blade assembly configuration used for experimental testing, has a span efficiency factor of 1.36 relative to a monoplane configuration. This being the case, it is logical to conclude that the aforementioned traditional wind turbine tip loss correction that is “built in” to the BEM model is over predicting the tip losses associated with the multiple airfoil configuration. Hence the tip loss correction must be modified to improve the accuracy of the BEM model results for wind turbines with multiple airfoil blade assemblies.

This observation is also reasonably consistent with the earlier calculation of span efficiency, which was determined to be 1.181 based on the equations which are repeated below for clarity;

Biplane span efficiency, c, calculation;

$$g = c = 2.5$$

$$σ = \frac{1}{1 + 5.3 \frac{g}{b}} = \frac{1}{1 + 5.3 \frac{2.5}{30}} = 0.694$$

$$e = \frac{2}{1 + σ} = \frac{2}{1 + 0.694} = 1.181$$

However it should be noted that the earlier calculation was done for a simplified case where the total lift of the monoplane and biplane configurations was assumed to be the same, and as a result the chord length of the biplane wings was actually shorter than that of the monoplane wings. The increased span efficiency of 1.36 presented in FIG. 8, on the other hand, was based on an “ideal” configuration where, presumably, the chord lengths were the same for both configurations. In this case the biplane lift would be approximately double that of the underlying monoplane configuration. A quick comparison of the numbers and their related configurations indicates that span efficiency actually goes up with increased biplane lift, a trend which can be used advantageously when optimizing the design of multiple airfoil blade assemblies for maximum performance.

It may also be observed from FIG. 8 that a biplane configuration with joined tips, i.e. the “box wind” structure shown in the bottom right corner, offers and even higher span efficiency of 1.46 relative to the aforementioned 1.36, which is the presumed theoretical maximum for the experimental configuration. Thus it is likely that the performance of a multiple airfoil blade assembly may be increased by joining the tips, and an examination of the aerodynamic data associated with various biplane configurations indicates that this performance may be further increased if the airfoils converge at the tips, i.e. have no stagger at the tips. The joined tip configuration also provides a structural advantage, in that the box like structure formed by the combined roots and joined tips of a multiple airfoil blade assembly is inherently stronger and can therefore be made lighter than the experimental configuration, which did not have joined tips.

Returning to the analysis at hand, the Prandtl tip loss model which is currently implemented in the BEM model, i.e. for traditional wind turbines, is shown below. The correction factor, F, is a function of the exponent f, which in turn is a function of the number of blades, B, the local radius r, the rotor radius, R, and the inflow angle φ.

$$F = \frac{2}{π} {cos}^{- 1} {e}^{- f}$$

where,

$$f = \frac{B}{2} \frac{R - r}{r sin ϕ}$$

The tip loss correction factor F must be calculated for each element of the blade. It is then multiplied by the power output, as initially calculated by the BEM model, to determine the adjusted power output for each element. As a result the total power produced by the blades will be reduced, to account for the tip losses.

However, as previously noted, the Prandtl tip loss model does not accurately account for the reduced tip losses associated with a multiple airfoil wind turbine when B=3, even though the turbine is technically configured with three multiple airfoil blade assemblies. And unfortunately there is no known way to modify the Prandtl model so that it accounts for the aforementioned increase in span efficiency from 1.0 (monoplane) to 1.36 (biplane optimum without joined tips) when determining the tip loss correction factor. Hence an alternative approach was developed to effectively reduce the tip loss correction factor and study the effect on the BEM model results.

It was found that an alternative approach was to represent the three multiple airfoil assemblies as six blades, since each assembly was comprised of two blades and hence two tips. It may be understood intuitively that increasing the number of blades from B=3 to B=6 will have the effect of doubling the exponent f, which in turn will have the effect of increasing the tip loss correction factor F, with reference to the above equations. It follows that increasing the tip loss correction factor F will effectively emulate the reduction in tip losses that is associated with multiple airfoil blade assemblies. While not necessarily quantitatively accurate, this approach will affect the BEM model results in a manner that is consistent with the reduced tip losses and increased spanwise efficiency of a biplane with fixed wings, now applied to a multiple airfoil wind turbine with rotating blades.

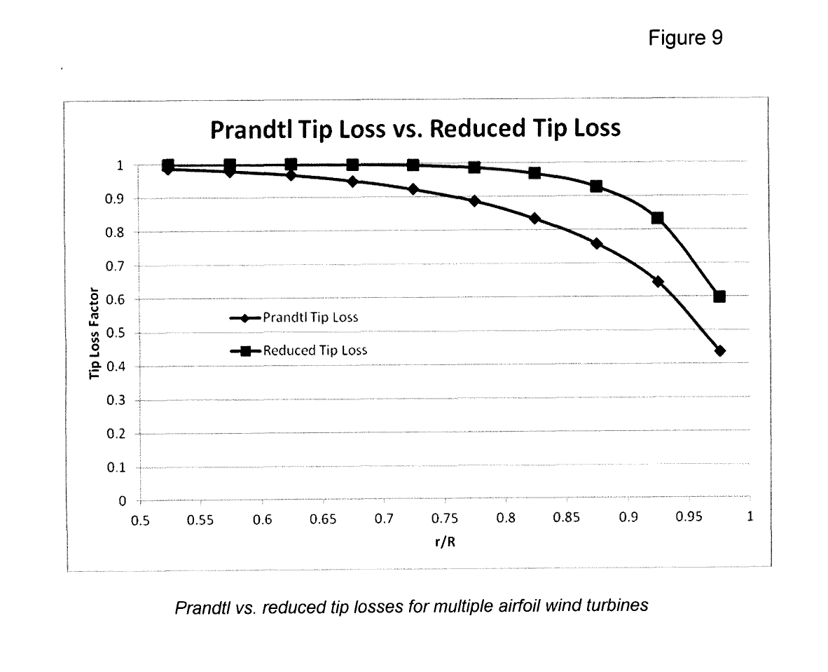

The effects of this approach on the Prandtl tip loss equation have been summarized in FIG. 9. It may be seen that the redubed tip loss curve, which is based on six “traditional” blades, does indeed provide higher tip loss correction factors in the tip area, which will effectively increase power output. For example, at 87.5% of the blade radius the tip loss correction factors are 0.758 and 0.928 for the Prandtl (traditional wind turbine) and “reduced” (multiple airfoil wind turbine) tip loss equations, respectively. As a result only 75.8% of theoretical power is actually available in the traditional wind turbine, due to tip losses, whereas a greatly increased 92.8% of that power is available in the multiple airfoil wind turbine, because the tip losses have been reduced. Again, this is due to the increased span efficiency associated with the three multiple airfoil blade assemblies.

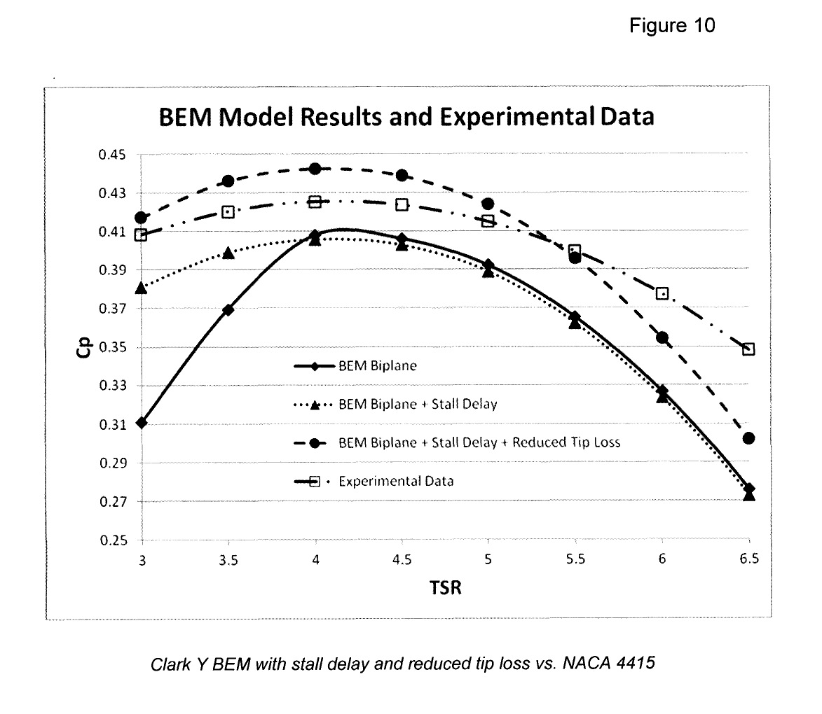

As a result the BEM model was updated with an algorithm for approximating the reduced tip loss correction factors, by changing the number of blades “B” to six, and the results are presented in FIG. 10.

It should be noted that reducing the tip losses does indeed raise the Cp curve for all values of TSR, as expected, such that the Clark Y corrected BEM results are now much closer to the NACA 4415 experimental results, in magnitude and in shape. The remaining differences are likely due to inaccuracies in the reduced tip loss model, aerodynamic differences between the Clark Y and NACA 4415 airfoils, or some combination thereof. Nonetheless, the curves are close enough that it may concluded that the third major contributor to the enhanced performance associated with multiple airfoil blade assemblies for wind turbines is a reduced induced drag, or reduced tip losses relative to a traditional wind turbine configuration.

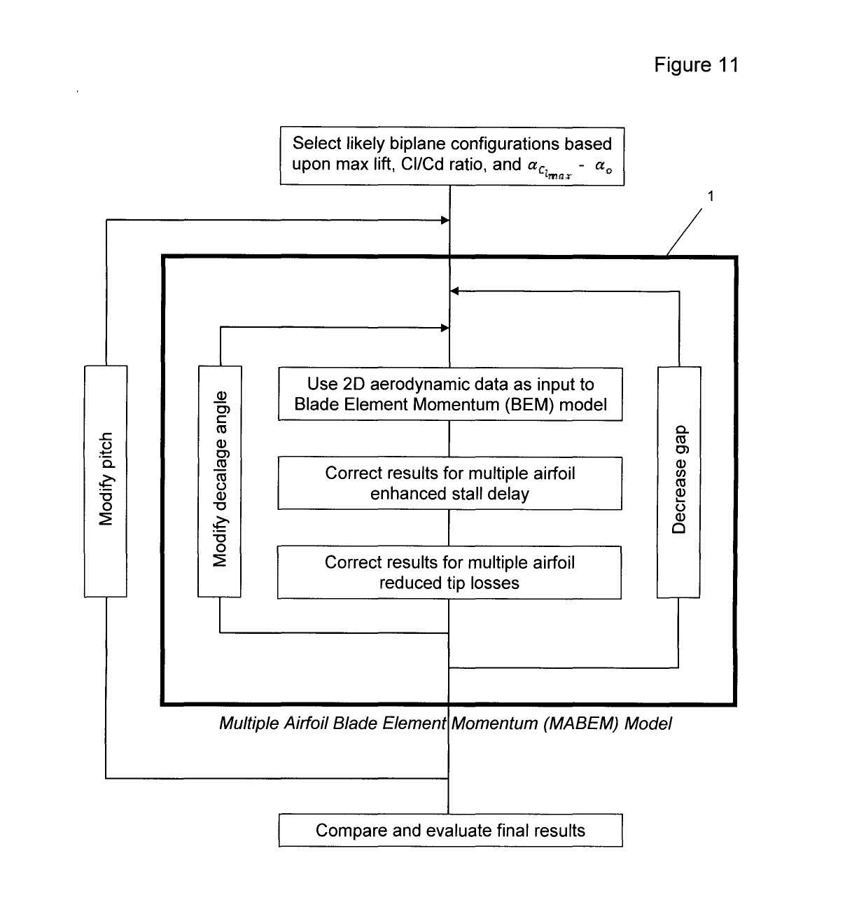

The discovery and understanding of the three major aerodynamic principles contributing to the enhanced performance of multiple airfoil wind turbine blade assemblies, i.e. the greater lift, improved lift/drag ratio and larger difference between [symbol] and αₒ associated with certain biplane configurations, the enhanced dynamic or rotational stall, and the reduced tip losses, led to an improved method for modelling the performance of multiple airfoil wind turbine blade assemblies, as depicted in FIG. 11. This improved method was then used to optimize the multiple airfoil wind turbine blade assembly configuration, leading to the preferred embodiments disclosed herein. It should be understood that these are only by way of example, and to identify the preferred use of the invention known to the inventor at this time. It is believed that further advances and optimization methods will become obvious, and that the multiple airfoil assembly has many additional uses that will become obvious, once one is familiar with the fundamental principles taught herein.

A multiple airfoil wind turbine blade assembly with two airfoils, one upwind or primary airfoil and one downwind or secondary airfoil, may be characterized by the following design parameters;
1) Gap—The axial distance between the leading edges of the two airfoils, at the same radius, normalized to the chord length of the primary airfoil at that radius.
2) Stagger—The angular distance between the leading edges of the two airfoils, at the same radius, normalized to the chord length of the primary airfoil at that radius. Positive stagger occurs when the secondary airfoil is leading the primary airfoil into the wind, i.e. when the secondary airfoil is leading the primary airfoil in the direction of rotation.
3) Pitch—The pitch angle of the primary airfoil at a given radius
4) Decalage—The difference in pitch angles of the primary and secondary airfoils, at the same radius. Positive decalage occurs when the secondary airfoil is set at a greater pitch angle than the primary airfoil, at the same radius.

A range of potential biplane configurations was initially identified by correcting the available Clark Y biplane data for 3D effects, and evaluating the results based on the above noted multiple airfoil wind turbine blade assembly performance factors such as maximum lift, Cl/Cd ratio, and [symbol] -αₒ. The most ideal configurations were then replicated using NACA 4415 airfoils and tested in a wind tunnel to produce the required MACA 4415 2D aerodynamic data. A further sensitivity analysis was then carried out to determine if small changes in these basic configurations would improve the multiple airfoil wind turbine blade assembly performance characteristics. Finally, the two most ideal NACA 4415 configurations were selected for further modelling and analysis, as summarized in the following table;

| NACA 4415 Configuration | Gap | Stagger |
|---|---|---|
| 1 | 0.8 | −0.8 |
| 2 | 0.8 | +0.6 |

The 2D aerodynamic data for these configurations was used as input for the disclosed Multiple Airfoil BEM (MABEM) model, as depicted in FIG. 11. The first step in this process is a standard BEM model, such as NREL's WT-perf code, followed by corrections for the (i) enhanced stall delay, and (ii) reduced tip losses found to be associated with multiple airfoil wind turbine blade assemblies, using the methods described herein. The decalage angle was then adjusted to see if that would improve the performance or control characteristics, then the gap was reduced to determine the determine the impact on performance. Generally speaking, a reduction in gap will reduce the overall dimensions of a multiple airfoil blade assembly, representing an advantage if it does not significantly reduce the overall performance.

The output of the MABEM model was then tested for sensitivity to pitch using traditional methods, i.e. by changing the pitch angle and repeating the MABEM process. This approach may be used to determine the optimum pitch for a stall controlled turbine, or to predict the response to changes in pitch for a pitch controlled turbine. In any event, the processes contained within the MABEM model must be replicated for each pitch angle to ensure that performance is accurately predicted for the optimized multiple airfoil wind turbine blade assembly.

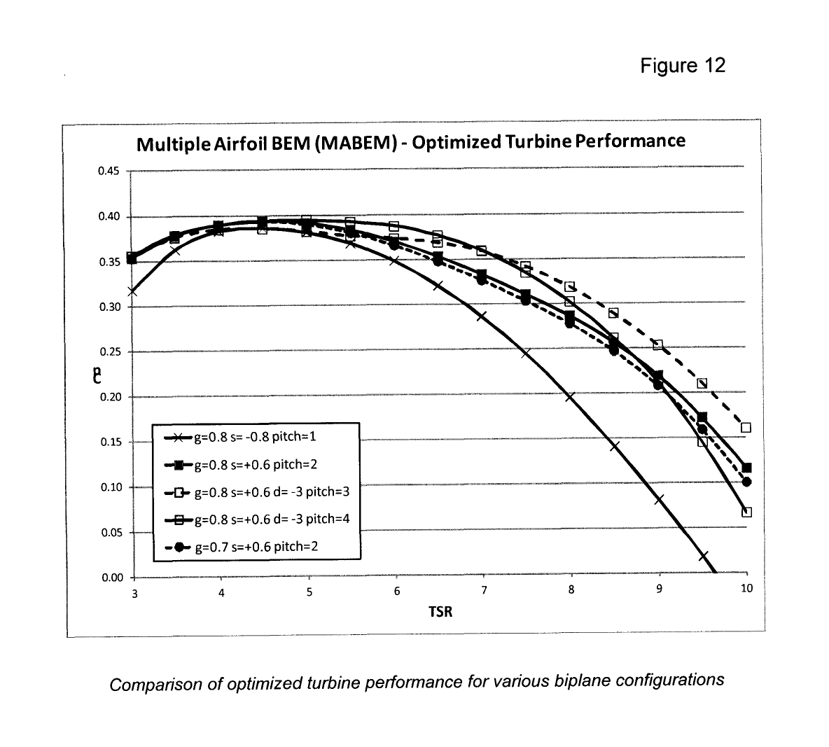

The results of this process have been summarized in FIG. 12. Here it may be observed that both configurations provide approximately the same maximum performance, i.e. a Cp of ˜3.9 at a TSR of 4.5, albeit at slightly different pitch angles. However the performance of configuration 1, with negative stagger, falls off more sharply at higher than optimum TSRs than the performance of configuration 2, with positive stagger. Hence configuration 1 may be more suitable for smaller stall control turbines, where a predictable and abrupt reduction in performance is necessary to prevent a potential overspeed situation. Conversely, the performance of configuration 2, with positive stagger, does not deteriorate so quickly at higher TSRs, which means that it may be more suitable for larger pitch controlled turbines where consistent performance and tolerance to wind gusts is more critical. With this in mind, the performance of variations to configuration 2 was determined using the MABEM model, as well as the response to pitch control.

It may be seen from FIG. 12 that introducing a decalage angle (d) of −3 degrees and increasing the pitch angle to 4 degrees “flattens” out the performance of configuration 2 to an even greater extent, while not reducing maximum performance, making it even more suitable for pitch controlled turbines and improving start-up performance, when TSR values are characteristically high. Further, it should be note that configuration 2 with decalage still remains responsive to pitch control, since decreasing the pitch angle by even 1 degree reduces the Cp from TSR values of approximately 3.5 to 7.0.

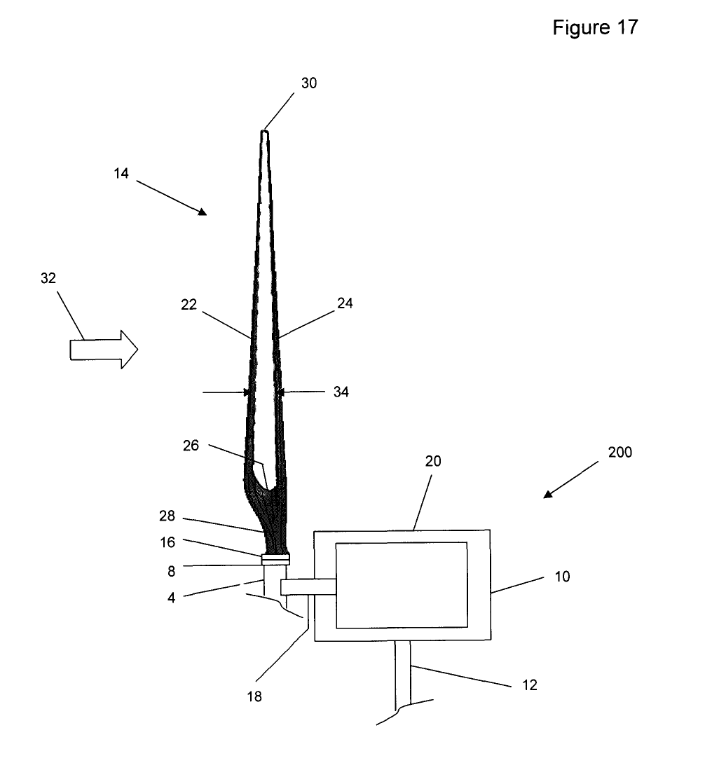

It may also be observed from FIG. 12 that decreasing the gap associated with configuration 2 from 0.8 to 0.7 chord does not affect maximum performance, and only has a very marginal effect on performance at TSRs above the optimum TSR. Thus it may be concluded that the reduction in overall dimensions may be accommodated without materially affecting the overall multiple airfoil wind turbine performance. This would improve the transportability of the blade, when it is lying in a horizontal position and there are tight restrictions for height and width, and also reduce the cantilever effect of the blade once installed, when it is in a vertical position and a decrease in gap would move the center of gravity back towards the nacelle, as illustrated in FIG. 17.

It was found during this process that multiple airfoil wind turbine blade assemblies may, in fact, be optimized for maximum performance at a certain TSR, a balanced combination of maximum performance and predictable stall for stall controlled wind turbines, or a balanced combination of maximum performance across a wide range of TSRs, to improve the controllability of pitch controlled wind turbines.

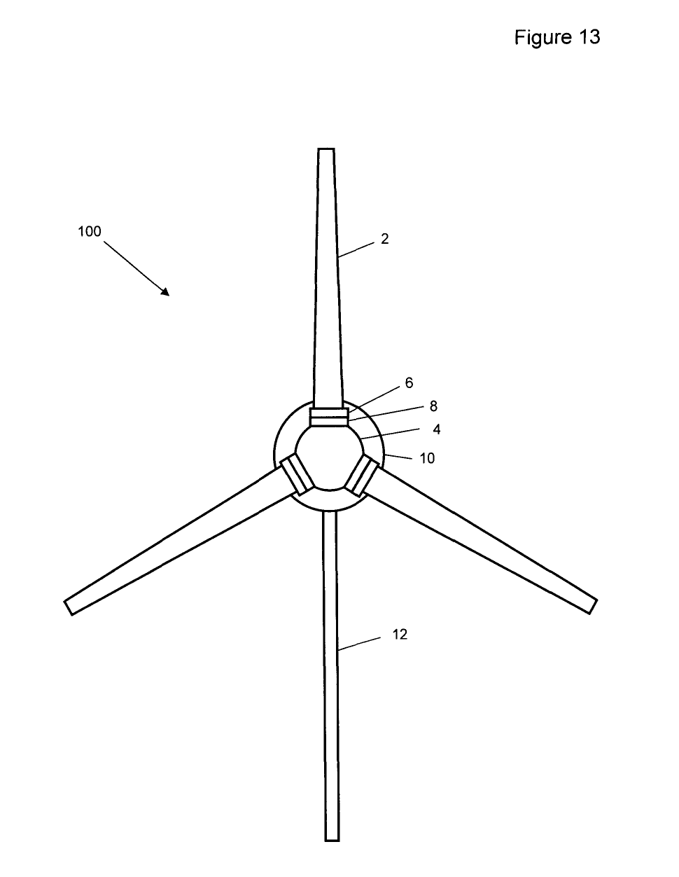

Turning now to FIGS. 13-22, embodiments of the optimized multiple airfoil wind turbine blade assembly shall be described in detail. The current invention also teaches that the structural integrity of a multiple airfoil wind turbine blade assembly may be enhanced with an internal spar structure, and further that the outer shell may be molded in two halves with a parting line that follows the edges of the internal spar structure. It follows that the three parts may be bonded along the parting line and internal spar edges to form a composite multiple airfoil assembly. This bonding may take place in a manufacturing facility or in the field, to improve the transportability of the parts, for the reasons outlined above.

FIG. 13 presents a front view of conventional wind turbine 100, configured with a single rotor having three blades at 120° intervals. Conventional blade 2 may be attached to conventional hub 4 by a number of bolts located around the perimeters of conventional root flange 6 and conventional hub flange 8. Conventional root flange 6 may be configured as an integral part of conventional blade 2, forming a rigid blade and root structure. Further, conventional hub flange 8 may be rotatingly attached to conventional hub 4, allowing the pitch angle of conventional blade 2 to be adjusted with respect to the wind, thereby controlling conventional wind turbine 100. Other major components of conventional wind turbine 100 include nacelle 10, housing the generator (not shown), and mast 12.

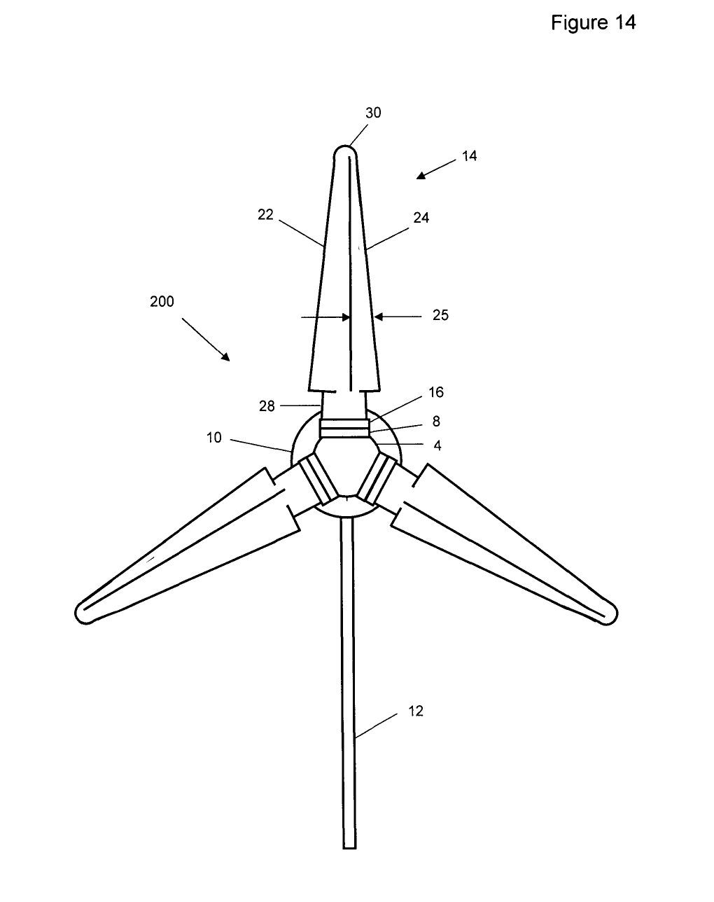

FIG. 14 presents a front view of a conventional wind turbine configured with three multiple airfoil wind turbine assemblies 14. A wind turbine so configured will be henceforth referred to as multistage wind turbine 200.

Multiple airfoil assembly 14 may be attached to conventional hub 4 by a number of bolts located around the perimeters of multiple airfoil root flange 16 and conventional hub flange 8. The bolt pattern on multiple airfoil root flange 16 may be intentionally configured to match the bolt pattern on conventional hub flange 8, allowing multiple airfoil assembly 14 to replace a conventional blade while still using the same conventional hub 4. Further, conventional hub flange 8 may be rotatingly attached to conventional hub 4, allowing the pitch angle of multiple airfoil assembly 14 to be adjusted with respect to the wind, thereby controlling multistage wind turbine 200. Slight variations in other turbine characteristics such as yaw response, ideal tip speed ratios (TSR), etc. may be accommodated by upgrading the turbine control software. Other major components of conventional wind turbine 100, including nacelle 10, mast 12 and the generator (not shown), would remain substantially the same.

Multiple airfoil assembly 14 may be configured with primary airfoil 22 and secondary airfoil 24, with primary airfoil 22 being the upwind airfoil and secondary airfoil 24 being the downwind airfoil. Primary airfoil 22 and secondary airfoil 24 may be of the same or different composition and/or geometry, to produce the most ideal combined aerodynamic, structural and acoustic qualities. Multiple airfoil assembly 14 may be further configured with combined root 28 and combined tip 30.

Primary airfoil 22 and secondary airfoil 24 may be configured as two independent airfoils, in which case aerodynamic stagger 25 may be defined as the distance between the leading edges of primary airfoil 22 and secondary airfoil 24, when viewed from the front of multiple airfoil assembly 14. Aerodynamic stagger 25 is usually referenced or “normalized” to the chord length (or width) of the airfoils at any given point along the radius of the airfoils. It has been found that a relatively consistent aerodynamic stagger 25, when normalized to chord length in this manner, produces a first level of optimized performance. It follows that the actual aerodynamic stagger 25 tapers from root to tip, just as the chord length of primary airfoil 22 and secondary airfoil 24 tapers from root to tip. It has been found experimentally and using the optimization method taught herein that configuring primary airfoil 22 and secondary airfoil 24 with an aerodynamic stagger 25 of about +1-0.06 to 1.0 chord, i.e. 60% to 100% of the chord length, provides an optimum balance of maximum performance with minimum distance between the leading edges of the airfoils, when viewed from the front of multiple airfoil assembly 14. Gradually reducing aerodynamic stagger from about +/−0.60 to 1.0 chord at the root to about 0.00 chord at the tip may lead to further aero structural optimization.

Multiple airfoil assembly 14 may be configured symmetrically with respect to conventional hub 4, when viewed from the front, to keep the mass of multiple airfoil assembly 14 balanced over conventional hub 4. In alternate configurations multiple airfoil assembly 14 may be intentionally skewed to the left or to the right, when viewed from the front of multiple airfoil assembly 14, to more closely match the balance associated with the traditional wind turbine blade that is being replaced by multiple airfoil assembly 14.

Combined tip 30 may be configured to form a junction between the tip of primary airfoil 22 and the tip of secondary airfoil 24. Combined tip 30 greatly enhances the structural integrity of multiple airfoil assembly 14. Combined tip 30 also increases the performance of multiple airfoil assembly 14 by increasing the span efficiency factor of multiple airfoil assembly 14, as defined in Prandtl's lifting line theory and as previously discussed.

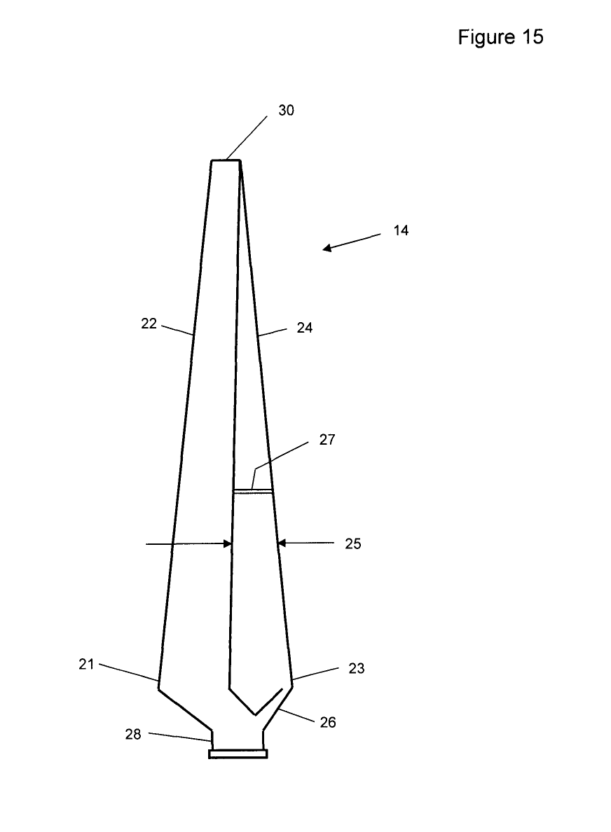

FIG. 15 presents a front view of an embodiment of multiple airfoil assembly 14, with primary airfoil 22 and secondary airfoil 24. In this configuration aerodynamic stagger 25 may be about 0.06 to 1.0 chord at the root and about 0.00 chord at the tip, to reduce the overall frontal area of the blade, thereby reducing the toppling wind force on the turbine structure. Further, reducing aerodynamic stagger 25 to about 0.00 chord at the tip improves the structural integrity of combined tip 30 by more directly translating the forces from primary airfoil 22 to secondary airfoil 24. However maintaining aerodynamic stagger 25 at about 0.06 to 1.0 chord in the root area retains the delayed stall characteristics of a positive stagger configuration, thereby contributing to the enhanced dynamic stall benefits associated with multiple airfoil assembly 14.

In this embodiment multiple airfoil assembly 14 may also be configured with strut 27, or multiple struts 27, to improve the structural integrity of multiple airfoil assembly 14. Strut 27 may be designed to provide a rigid support between primary airfoil 22 and secondary airfoil 24, while producing minimum drag as multiple airfoil assembly 14 rotates in the wind. For example strut 27 may be arched, such that all points on the bottom and top surfaces are at a lesser and greater equal distance from the axis of rotation, respectively. Further, strut 27 may be configured with a sharp leading edge to minimize drag.

Primary airfoil root 21 and secondary airfoil root 23 may be attached to combined root 28 through aerodynamic saddle 26. Aerodynamic saddle 26 may be designed to enhance the structural integrity of multiple airfoil assembly 14, improve the enhanced dynamic stall characteristics, and reduce drag. For example, aerodynamic saddle 26 may be configured with certain features to produce an enhanced radial flow of air between primary airfoil 22 and secondary airfoil 24, such as a top surface that is higher at the trailing edges than the leading edges of the airfoils, to improve the enhanced dynamic stall characteristics. Further, the leading edges of aerodynamic saddle 26, primary airfoil 22 and secondary airfoil 24 may be similarly configured and/or blended together at the interface points to reduce the overall drag. Aerodynamic saddle 26 may remain the same for use on different turbines, while combined root 28 may be changed to accommodate the various hub diameters and bolt patterns associated with different turbines.

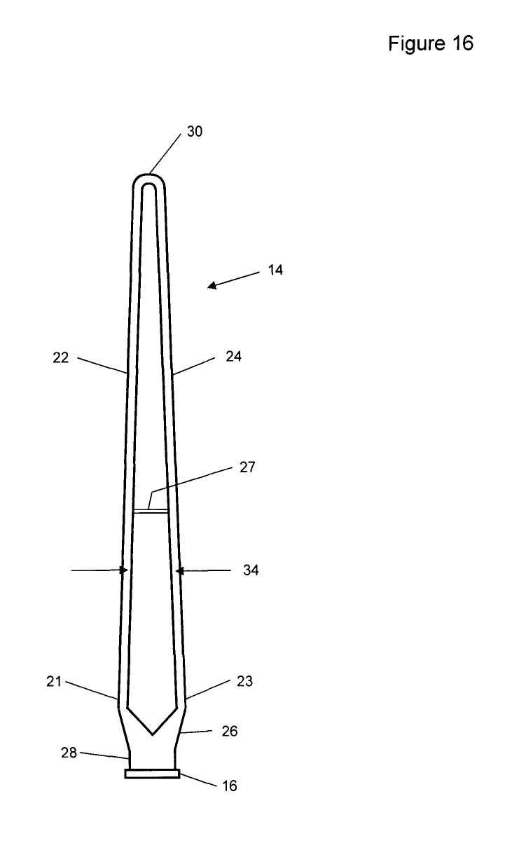

FIG. 16 presents a side view of the same embodiment of multiple airfoil assembly 14, with primary airfoil 22, secondary airfoil 24, combined tip 30, strut 27, aerodynamic saddle 26, combined root 28, and multiple airfoil root flange 16. Aerodynamic gap 34 may be defined as the distance between the leading edges of primary airfoil 22 and secondary airfoil 24, when viewed from the side of multiple airfoil assembly 14. Aerodynamic gap 34 is usually referenced or “normalized” to the chord length (or width) of the airfoils at any given point along the radius of the airfoils. It has been found that a relatively consistent aerodynamic gap 34, when normalized to chord length in this manner, produces optimum performance. It follows that the actual aerodynamic gap 34 tapers from root to tip, just as the chord length of primary airfoil 22 and secondary airfoil 24 tapers from root to tip. It has been found experimentally and using the optimization method taught herein that configuring primary airfoil 22 and secondary airfoil 24 with an aerodynamic gap 34 of about 0.70 to 1.0 chord, i.e. about 70% to 100% of the chord length, provides an optimum balance of maximum performance with minimum distance between the leading edges of the airfoils, when viewed from the side of multiple airfoil assembly 14.

Combined tip 30 may be configured with a straight portion in the middle and a curved portion at either end, to increase the span efficiency, as previously discussed, while alleviating the increased strain that would be associated with sharp corners at the junctions of combined tip 30 and the airfoils. Further, combined tip 30 may be configured with certain features to reduce drag, for example with a leading edge that is relatively similar to and conjoined with the leading edges of primary airfoil 22 and secondary airfoil 24.

It has been found that the curved portions of combined tip 30 are best configured similarly and with a mean radius that is less than 12% and preferably greater than 6% of the distance between the tips of primary airfoil 22 and secondary airfoil 24. Further, it has been found that the straight portion of combined tip 30 is best configured to be at not less than 90 degrees to primary airfoil 22 and secondary airfoil 24, and in this embodiment may be at right angles to a centre line that falls in between primary airfoil 22 and secondary airfoil 24.

FIG. 17 presents a side view of a conventional wind turbine configured with multiple airfoil assemblies 14 in an alternative embodiment. A wind turbine so configured will be henceforth referred to as multistage wind turbine 200.

Multiple airfoil assembly 14 may be attached to conventional hub 4 by a number of bolts located around the perimeters of multiple airfoil root flange 16 and conventional hub flange 8. The bolt pattern on multiple airfoil root flange 16 may be intentionally configured to match the bolt pattern on conventional hub flange 8, allowing multiple airfoil assembly 14 to replace a conventional blade while still using the same conventional hub 4. Further, conventional hub flange 8 may be rotatingly attached to conventional hub 4, allowing the pitch angle of multiple airfoil assembly 14 to be adjusted with respect to the wind, thereby controlling multistage wind turbine 200.

Conventional hub 4 may be attached to generator 20 through main shaft 18. Further, generator 20 may be housed within nacelle 10, which in turn may be configured atop mast 12.

Multiple airfoil assembly 14 may be configured with primary airfoil 22 and secondary airfoil 24; primary airfoil 22 being the upwind airfoil and secondary airfoil 24 being the downwind airfoil. Multiple airfoil assembly 14 may be further configured with combined root 28 and combined tip 30.

Primary airfoil 22 and secondary airfoil 24 may be configured as two independent airfoils, in which case aerodynamic gap 34 may be defined as the distance between the leading edges of primary airfoil 22 and secondary airfoil 24, when viewed from the side of multiple airfoil assembly 14. Aerodynamic gap 34 is usually referenced or “normalized” to the chord length (or width) of the airfoils at any given point along the radius of the airfoils (reference FIG. 14). It has been found that a consistent aerodynamic gap 34, when normalized to chord length in this manner, produces optimum performance. It follows that the actual aerodynamic gap 34 tapers from root to tip, just as the chord length of primary airfoil 22 and secondary airfoil 24 tapers from root to tip. It has been found experimentally that configuring primary airfoil 22 and secondary airfoil 24 with an aerodynamic gap 34 of 0.75 to 1.0 chord, i.e. 75% to 100% of the chord length, provides an optimum balance of maximum performance with minimum distance between the leading edges of the airfoils, when viewed from the side of multiple airfoil assembly 14.

It should be noted that multiple airfoil assembly 14 does not need to be symmetrical with respect to conventional hub 4. In this embodiment multiple airfoil assembly 14 may be configured such that secondary airfoil 24 rises substantially vertically above conventional hub 4, and further such that the base of primary airfoil 22 protrudes upwind with respect to conventional hub 4. This configuration allows multiple airfoil assembly 14 to be mounted on conventional hub 4 while providing adequate clearance between multiple airfoil assembly 14, mast 12 and nacelle 10, as well as other existing turbine components.

Aerodynamic saddle 26 may be configured to form a junction between the base of primary airfoil 22, the base of secondary airfoil 24 and combined root 28, while introducing a minimum amount of aerodynamic drag. Further, aerodynamic saddle 26 may be configured with one or more aerodynamic features to produce an enhanced radial component of airflow between primary airfoil 22 and secondary airfoil 24, thereby increasing the effects of dynamic stall and increasing the overall performance of multiple airfoil assembly 14.

Combined tip 30 may be configured to form a junction between the tip of primary airfoil 22 and the tip of secondary airfoil 24. Combined tip 30 greatly enhances the structural integrity of multiple airfoil assembly 14. Combined tip 30 also increases the performance of multiple airfoil assembly 14 by increasing the span efficiency factor of multiple airfoil assembly 14, as defined in Prandtl's lifting line theory.

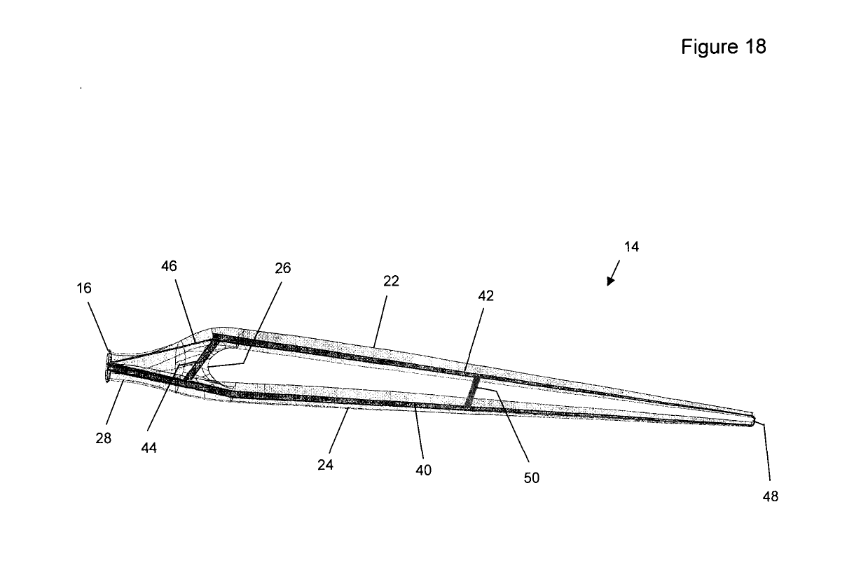

FIG. 18 presents a side cutaway view of the same embodiment of multiple airfoil assembly 14 in a horizontal orientation, showing the internal beam structure. Multiple airfoil assembly 14 is shown in this orientation so that it may be compared with a cantilevered king truss structure.

During normal operation secondary airfoil 24 is on the downwind side, as illustrated in FIG. 16, and bears the combined wind load. Hence secondary airfoil 24 contains main load bearing beam 40, which extends from combined structural tip 48 to combined root 28. Main load bearing beam 40 may be configured as an “I beam” or some similar structural member. Further, main load bearing beam 40 may be affixed to multiple airfoil root flange 16 for greater rigidity.

Primary airfoil 22 contains truss 42, which extends from combined structural tip 48 to the top of king post 44. Truss 42 bears the load associated with primary blade 22 and transfers it to main load bearing beam 40 through combined structural tip 48 and king post 44. King post 44 may be affixed to main load bearing beam 40 within the volume of aerodynamic saddle 26. Truss 42 and king post 44 may be configured as “I beams” or similar structural members.

Tension rod 46 may be attached to the distal ends of main load bearing beam 40 and truss 42, and adjusted in length to create tension within truss 42. An increased tension within truss 42 will reduce the flexing of truss 42′under load, especially in the middle region. In some configurations supplementary strut 50 may be added to reduce the flexing of truss 42 and more effectively transfer the loads associated with truss 42 to main load bearing beam 40. Supplementary strut 50, if required, may be designed to contribute to the structural integrity of multiple airfoil assembly 14 in this manner, while minimizing any incremental drag. Supplementary strut 50 may be used in applications that require “stiff” blades as opposed to blades that are designed to intentionally flex in gusts and stronger winds. In certain applications multiple airfoil assembly 14 may also be designed with similar flexing properties, and may actually respond in a more predictable manner than conventional blades.

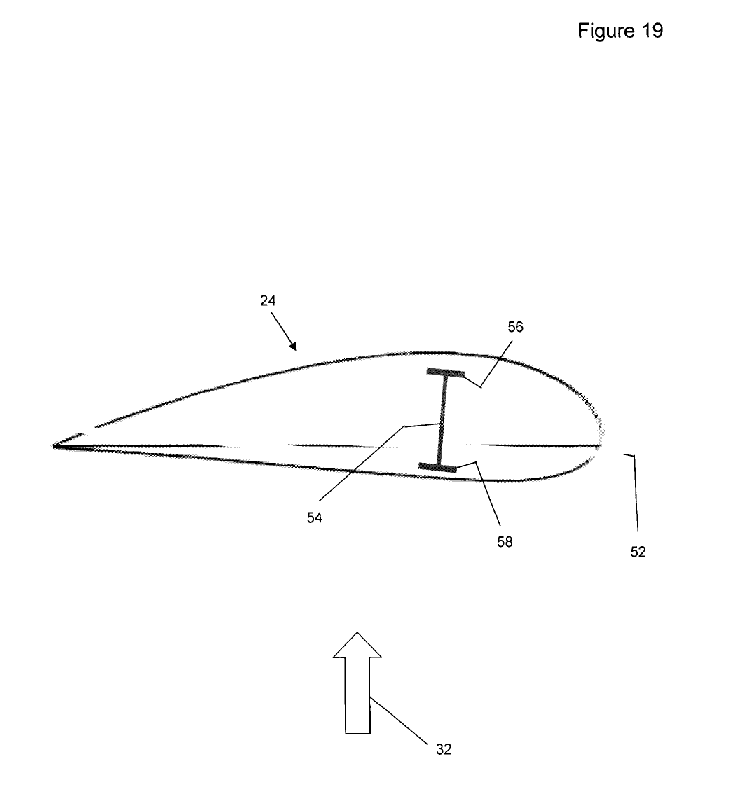

FIG. 19 presents a cross section view of secondary airfoil 24 with an internal spar structure, which is a practical means of implementing main load bearing beam 40, with reference to FIG. 18. Secondary airfoil 24, with leading edge 52, is subject to the forces of wind 32. In this embodiment the “I Beam” structure of main load bearing beam 40 has been implemented with the combined configuration of main load bearing spar 54, main upwind spar cap 58, and main downwind spar cap 56. Main upwind spar cap 58 and main downwind spar cap 56 may be configured to spread the loads borne by main load bearing spar 54 across a greater portion of the surfaces of secondary airfoil 24. Main load bearing spar 54, main upwind spar cap 58, and main downwind spar cap 56 may be bonded or formed as one part using composite materials, or created with a combination of materials such as wood and composite materials. Further, main upwind spar cap 58 and main downwind spar cap 56 may be bonded to the inner surface of secondary airfoil 24 for greater rigidity.

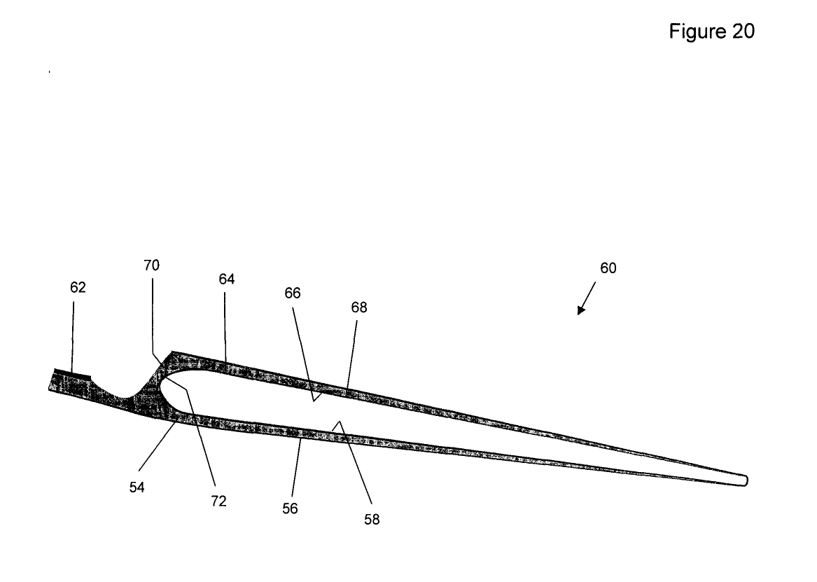

FIG. 20 presents a side view of internal spar structure 60, which is one embodiment of the beam structure introduced on FIG. 18. In this configuration main load bearing spar 54, main upwind spar cap 58, main downwind spar cap 56 and main root spar cap 62 may be combined to form main load bearing beam 40, with reference to FIG. 17. Further, truss spar 64, truss upwind spar cap 68 and truss downwind spar cap 66 may be combined to form truss 42, again with reference to FIG. 18. Further, saddle spar 70 and saddle spar cap 72 may be combined to form king post 44, again with reference to FIG. 18. It should be noted that all of the above noted spars and spar caps may be bonded or formed as one part using composite materials, or created with a combination of materials such as wood and composite materials.

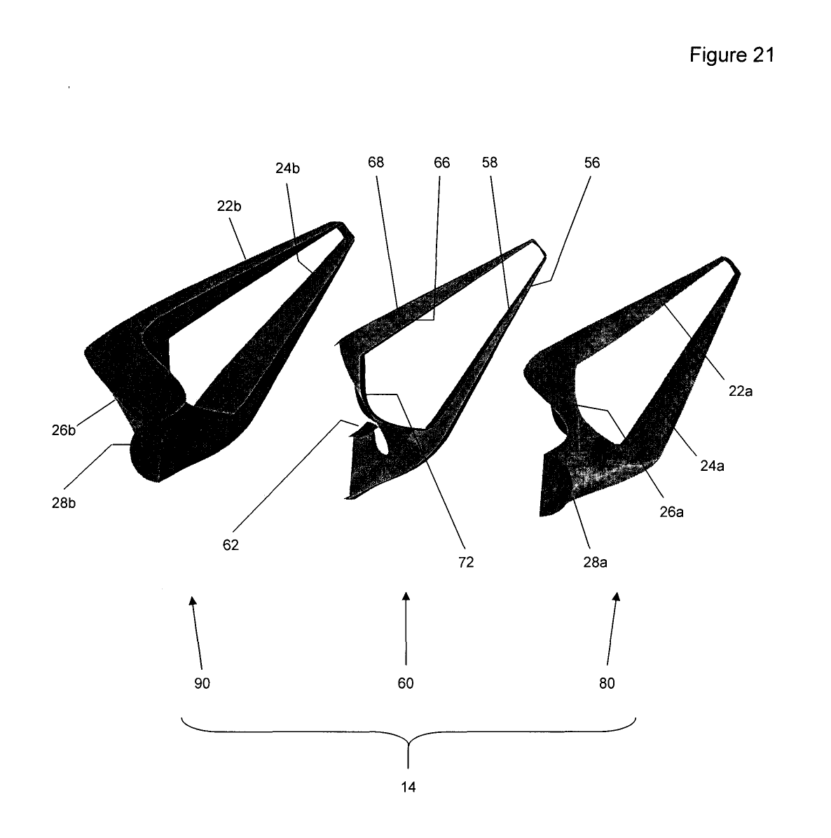

FIG. 21 presents a cutaway view of a tooling configuration for the same embodiment of multiple airfoil assembly 14, allowing it to be manufactured in three parts. Leading edge sub-assembly 80 may be configured with primary airfoil leading edge portion 22a, secondary airfoil leading edge portion 24a, saddle leading portion 26a and combined root leading portion 28a. Trailing edge subassembly 90 may be configured with primary airfoil trailing edge portion 22b, secondary airfoil trailing edge portion 24b, saddle trailing portion 26b and combined root trailing portion 28b. The parting lines between leading edge assembly 80 and trailing edge assembly 90 may be configured to run along the centre of main upwind spar cap 58, truss downwind spar cap 66, saddle spar cap 72 and adjoining lines on the inside, and main downwind spar cap 56, truss upwind spar cap 68, main root spar cap 62 and adjoining lines on the outside. Internal spar structure 60 may be bonded within leading edge sub-assembly 80 and trailing edge sub-assembly 90 to form one composite structure for multiple airfoil assembly 14.

Alternative tooling configurations are also possible, for example by creating four subassemblies as follows; primary airfoil 22, secondary airfoil 24, combined tip 30, and aerodynamic saddle 26 together with combined root 28, with reference to FIG. 15. In this case each subassembly may contain an appropriate portion of internal spar structure 60, with interlocking features to ensure the structural integrity of internal spar structure 60, with reference to FIG. 20. The four subassemblies may be bonded in the manufacturing facility or in the field, to improve transportability as previously described. In any event, alignment features may be built into combined tip 30 and aerodynamic saddle 26 to ensure the correct and accurate assembly of multiple airfoil assembly 14, again with reference to FIG. 15, for example by allowing a portion of combined tip 30 to extend into the distal ends of primary airfoil 22 and secondary airfoil 24. Further, combined tip 30 may be constructed of cast aluminum for increased strength, then machined for greater dimensional accuracy. Certain additional features, such as a lightning rod or a receptacle for a lightning rod, may also be advantageously incorporated into combined tip 30 when constructed of aluminum or other high strength conductive material.

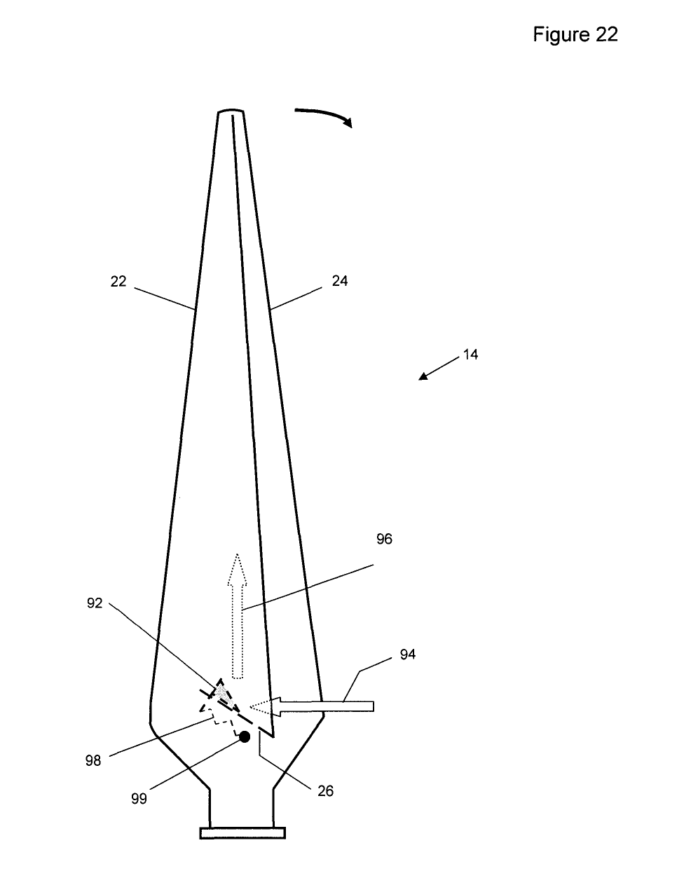

FIG. 22 presents a front view of multiple airfoil assembly 14 with adjustable radial flow deflector 92. Multiple airfoil assembly 14 may be configured to rotate in a clockwise direction, which produces induced airflow 94. Induced airflow 94 is then deflected by the inclined surface of aerodynamic saddle 26 and adjustable radial flow deflector 92 to produce radial airflow 96. Radial airflow 96 flows between primary airfoil 22 and secondary airfoil 24 in the radial direction, to enhance the effects of dynamic stall and increase wind turbine performance.

Adjustable radial flow deflector 92 may be adjusted upwards, to move radial flow 96 closer to the trailing edges of primary airfoil 22 and secondary airfoil 24, or downwards, to move radial flow 96 closer to the leading edges of primary airfoil 22 and secondary airfoil 24. Radial flow 96 may be controlled in this manner, in various wind and load conditions, to direct it at the flow separation point on the airfoils, thereby enhancing the delayed stall effects and optimizing turbine performance.

In some embodiments radial flow deflector 92 may be controlled by a combination of centrifugal force and return spring 98. In this case an increase in rotational speed would, through centrifugal force, move radial flow deflector 92 up and to the left, along the surface of aerodynamic saddle 26, effectively moving radial flow 96 closer to the trailing edges of primary airfoil 22 and secondary airfoil 24. Conversely a decrease in rotational speed would reduce the centrifugal force and allow the tension in return spring 98 to draw radial flow deflector 92 back down and to the right, effectively moving radial flow 96 closer to the leading edges of primary airfoil 22 and secondary airfoil 24. Various other control mechanisms may be used, including linear actuators and the like. In other embodiments radial flow deflector 92 may be fixed at a location that is optimal for local wind conditions, or it may be implemented as a permanent feature on the inclined surface of aerodynamic saddle 26. In further embodiments radial flow deflector 96 may be configured to substantially stop radial flow 96, thereby interrupting the dynamic stall effect and acting as a type of aerodynamic brake, for example by allowing radial flow deflector 92 to rotate counter-clockwise such that its bottom surface extends horizontally from the top of aerodynamic saddle 26, to stop the radial progression of radial flow 96.

It is quite likely that multiple airfoil assembly 14 may be further optimized with intentional variations in gap, stagger and decalage angles along its length, for example; to create virtual twist while simplifying the combined blade geometry, to maximize the overall torque, and so on, Similar approaches may also be used to optimize the distribution of lift on the two airfoils, allowing for reduced mass of the overall structure. For example, it has been found that reducing the chord length of primary airfoil 22 to about 70% to 80% of the chord length of secondary airfoil 24, at all points along the length of the airfoils, may lead to further aero structural optimization.

In certain configurations, for example when using multiple airfoil assembly in new installations, it may also be possible to use additional control techniques to adjust and optimize the multistage blade while it is operating, for example by adjusting the decalage on all or part of the blade, or by incorporating additional controllable features to initiate, enhance or actively stop the effects of dynamic stall, when required. Other control and optimization techniques will become evident as more is learned about the aerodynamics of multiple airfoil wind turbine blades.

The optimized multiple airfoil assembly of the present invention allows for many applications. Although reference is made to the embodiments listed above, it should be understood that these are only by way of example and to identify the preferred use of the invention known to the inventor at this time. It is believed that the multiple airfoil assembly has many additional embodiments and uses, for example in thrust applications, which will become obvious once one is familiar with the fundamental principles of the invention.

The invention claimed is:

1. A method for optimizing a multiple airfoil blade assembly for a wind turbine, said method comprising;
a. A set of criteria for selecting potentially optimum airfoil configurations,
b. A Blade Element Momentum theory model,
c. A first methodology for increasing the predicted performance of said wind turbine due to the enhanced rotational stall delay of said multiple airfoil blade assembly, and
d. A second methodology for increasing the predicted performance of said wind turbine due to the reduced tip losses of said multiple airfoil blade assembly,
wherein said method may be repeated for a number of said potentially optimum airfoil configurations, to determine the optimum airfoil configuration.

2. The method of claim 1, wherein said set of criteria includes maximum lift.

3. The method of claim 1, wherein said set of criteria includes maximum lift to drag ratios.

4. The method of claim 1, wherein said set of criteria includes maximum difference between the angle of attack for zero lift and the angle of attack for maximum lift.

5. The method of claim 1, wherein said multiple airfoil blade assembly is comprised of a primary airfoil and a secondary airfoil, and wherein there is an aerodynamic gap between said primary airfoil and said secondary airfoil.

6. The method of claim 1, wherein said multiple airfoil blade assembly is comprised of a primary airfoil and a secondary airfoil, and wherein said primary airfoil is set at the same pitch angle as said secondary airfoil.

7. The method of claim 1, wherein said multiple airfoil blade assembly is comprised of a primary airfoil and a secondary airfoil, and wherein said primary airfoil is set at a different pitch angle than said secondary airfoil.

8. The method of claim 1, wherein said optimum airfoil configuration provides maximum performance that drops off rapidly with increasing tip speed ratios.

9. The method of claim 1, wherein said optimum airfoil configuration provides maximum performance that does not drop off rapidly with increasing tip speed ratios.

10. The method of claim 1, wherein said optimum airfoil configuration provides reduced maximum performance, and wherein said optimum airfoil configuration has reduced dimensions.

11. A multiple airfoil blade assembly for a wind turbine, having, when assembled on said wind turbine, a root portion proximal to the hub of said wind turbine and a tip portion distal to said hub, said wind turbine blade assembly comprising;
a. A primary airfoil having a primary leading edge and primary trailing edge, and
b. A secondary airfoil having a secondary leading edge and a secondary trailing edge:
wherein said primary airfoil is configured upwind of said secondary airfoil and there is an aerodynamic gap between said primary leading edge and said secondary leading edge.

12. The multiple airfoil blade assembly of claim 11, further comprising an internal spar.

13. The multiple airfoil blade assembly of claim 11, further comprising an internal spar, and wherein said internal spar is configured with an adjustable tension rod.

14. The multiple airfoil blade assembly of claim 11, wherein said primary airfoil and said secondary airfoil are at the same pitch angle.

15. The multiple airfoil blade assembly of claim 11, wherein said primary airfoil and said secondary airfoil are at different pitch angles.

16. The multiple airfoil blade assembly of claim 11, wherein said tip portion is configured with alignment features that may be affixed to the distal ends of said primary airfoil and said secondary airfoil.

17. The multiple airfoil blade assembly of claim 11, wherein said tip portion is constructed of conductive material and configured with a lightning device.

18. The multiple airfoil blade assembly of claim 11, wherein said root portion is configured with alignment features that may be affixed to the hub ends of said primary airfoil and said secondary airfoil.

19. The multiple airfoil blade assembly of claim 11, wherein said root portion is further comprised of an aerodynamic saddle, affixed to the hub ends of said primary blade and said secondary blade, and a combined root ring.

20. The multiple airfoil blade assembly of claim 11, wherein said secondary blade rotates substantially in the plane of rotation of said hub, and wherein said primary blade rotates in an alternate plane of rotation that is upwind of said plane of rotation of said hub.

21. The multiple airfoil blade assembly of claim 11, wherein said root portion is further comprised of an aerodynamic saddle, affixed to the hub ends of said primary blade and said secondary blade, and a combined root ring, and wherein said aerodynamic saddle is configured with radial flow inducing features.

22. The multiple airfoil blade assembly of claim 11, wherein said root portion is further comprised of an aerodynamic saddle, affixed to the hub ends of said primary blade and said secondary blade, and a combined root ring, and wherein said aerodynamic saddle is configured with a radial flow deflector that is activated by centrifugal force.

23. The multiple airfoil blade assembly of claim 11, wherein said wind turbine is controlled at a faster rate of rotation at start-up than during normal operation, to initiate radial flow.

24. The multiple airfoil blade assembly of claim 11, wherein said primary and secondary leading edges and the leading edge sides of said root and tip portions form a first sub-assembly, and said primary and secondary trailing edges and the trailing edge sides of said root and tip portions form a second sub-assembly, and wherein said sub-assemblies may be later bonded in the field.

25. The multiple airfoil blade assembly of claim 11, wherein said primary airfoil forms a first sub-assembly, said secondary airfoil forms a second sub-assembly, said root portion forms a third assembly and said tip portion forms a fourth sub-assembly, and wherein said sub-assemblies may be later bonded in the field.
